(19) United States
(12) Patent Application Publication
(10) Pub. No.: US 2009/0092860 A1
(43) Pub. Date: Apr. 9, 2009

(54) BATTERY PACK

(75) Inventors: Hiroshi YAMAMOTO, Ibaraki-shi (JP); Takashi Sumida, Ibaraki-shi (JP); Osamu Akatsuchi, Ibaraki-shi (JP)

Correspondence Address: BIRCH STEWART KOLASCH & BIRCH, PO BOX 747, FALLS CHURCH, VA, 22040-0747, US

(73) Assignee: HITACHI MAXELL, LTD., Ibaraki-shi (JP)

(21) Appl. No.: 12/238,236

(22) Filed: Sep. 25, 2008

(30) Foreign Application Priority Data
Sep. 26, 2007 (JP) 2007-249714
Sep. 27, 2007 (JP) 2007-251793
Sep. 28, 2007 (JP) 2007-256190

(51) Int. Cl. H01M 14/00

(52) U.S. Cl. 429/7

(57) ABSTRACT

A battery pack has a unit cell including a battery case having an opening and made of metal and including a sealing plate closing and sealing the opening of the battery case and made of metal, a circuit board having a safety circuit, and a holding member holding the circuit board, and employs a structure in which at least part of the holding member is fixed to the unit cell by laser welding. By the employment of such a structure, the battery pack can be provided in which the holding member holding the circuit board can reliably be fixed to the unit cell and of which total cost can be reduced by saving of labor of assembly that is achieved by simplification of a structure for fixing the holding member to the unit cell.

### BACKGROUND OF THE INVENTION

1. Field of the Invention

The present invention relates to a battery pack having a unit cell and a holder for holding a circuit board that is placed outside the unit cell.

2. Description of Related Art

Conventionally, there have been known such battery packs of this type as disclosed in Documents 1 through 3, for instance. In the battery packs disclosed in Documents 1 through 3, a circuit board having a safety circuit and the like are placed outside a sealing plate of a flat-shaped unit cell and are covered with an exterior cover, which is then fixed to the unit cell, so that the exterior cover holding the circuit board and the like is integrated with the unit cell.

In the battery pack of Document 1, specifically, the integration is achieved by fixation of the circuit board and the exterior cover to the unit cell by resin molding. In the battery pack of Document 2, fitting projections are provided on a board holder held between the circuit board and the unit cell and are engaged with fitting holes provided on the exterior cover, so that the exterior cover is fixed to and integrated with the unit cell. In the battery pack of Document 3, the exterior cover is fastened with screws onto nuts provided on the unit cell, so that the exterior cover is fixed to and integrated with the unit cell.

[Document 1] JP 2006-147329 A (FIG. 2)

[Document 2] JP 2007-73204 A (FIG. 3)

[Document 3] JP 2006-302662 A (FIG. 1)

### SUMMARY OF THE INVENTION

In accordance with Document 1, however, a forming die, a molding apparatus and the like are required for fixing the circuit board and the exterior cover to the unit cell by resin molding, and a disadvantage is thereby caused in that costs of facilities for manufacturing the battery pack are increased. In accordance with Document 2, for instance, there is a danger that a push on the fitting projections may make the exterior cover prone to easily come off the unit cell, and it is thus impossible to adequately protect the circuit board and the like. Besides, the holder is merely held between the circuit board and the unit cell without being fixed to the unit cell (see paragraph 0026 in Document 1), and there is a danger that the holder may easily come off the unit cell when being twisted, for instance. In accordance with Document 3, the exterior cover can be removed simply with the screws loosened by a screwdriver or the like, and thus it is also impossible to adequately protect the circuit board and the like. In accordance with Document 3, additionally, number of components of the battery pack is made all the larger for necessity for the screws and the like, and a disadvantage is thereby caused in that a cost of the battery pack is increased.

Though it is conceivable to fix the exterior cover to the unit cell with double-sided adhesive tape, adhesive agent, or the like, it is difficult to obtain high fixation strength from double-sided tape. Adhesive agent has disadvantages in that efficiency of manufacturing the battery packs is made the worse for much time spent for solidification and in that a cost of manufacturing the battery packs is made the higher for necessity of disposal of volatile component in the adhesive agent and the like.

Therefore, an object of the present invention is to solve problems described above and to provide a battery pack in which a holder holding a circuit board can reliably be fixed to a unit cell and of which total cost can be reduced by saving of labor of assembly that is achieved by simplification of a structure for fixing the holder to the unit cell.

In order to accomplish the above object, the invention is configured as follows.

According to a first aspect of the present invention, there is provided a battery pack comprising:

a unit cell including a battery case having an opening and a sealing plate closing and sealing the opening of the battery case, both of the battery case and sealing plate being made of metal;

a circuit board having a safety circuit; and

a holding member holding the circuit board and made of resin, wherein

at least part of the holding member is fixed to the unit cell by laser welding.

According to a second aspect of the present invention, there is provided the battery pack as defined in the first aspect, wherein

the holding member for holding the circuit board is an exterior cover that covers the circuit board and the sealing plate, the exterior cover being made of resin, and

at least part of an opening edge of the exterior cover is welded and fixed to the unit cell.

According to a third aspect of the present invention, there is provided the battery pack as defined in the second aspect, wherein a thin wall part is formed in the opening edge of the exterior cover so that a distance from a center of a welding region between the opening edge and the unit cell to an outer surface of the exterior cover is smaller than distances between outer and inner surfaces of the other parts of the exterior cover.

According to a fourth aspect of the present invention, there is provided the battery pack as defined in the third aspect, wherein a flat surface parallel to a welding surface between the exterior cover and the unit cell is formed in the thin wall part of the exterior cover, and a distance between the welding surface and the flat surface is smaller than the distances between the outer and inner surfaces of the other parts of the exterior cover.

According to a fifth aspect of the present invention, there is provided the battery pack as defined in the fourth aspect, wherein

a flange protruding outward is formed as the thin wall part on the opening edge of the exterior cover,

a surface of the flange continuing to the outer surface of the exterior cover is provided as the flat surface parallel to the welding surface, and

a surface of the flange opposed to the flat surface is welded and fixed to the unit cell.

According to a sixth aspect of the present invention, there is provided the battery pack as defined in the fourth aspect, wherein a skirt extending along an outer surface of the battery case is formed as the thin wall part on the opening edge of the exterior cover, and the outer surface of the battery case and inner surfaces of the skirt are welded and fixed to each other.

According to a seventh aspect of the present invention, there is provided the battery pack as defined in the second aspect, wherein

at least one welding protrusion is formed on periphery of an outer surface of the sealing plate of the unit cell, and

a surface of the welding protrusion and an inner peripheral surface of the exterior cover are welded and fixed to each other.

According to an eighth aspect of the present invention, there is provided the battery pack as defined in the second aspect, wherein a holder made of resin is placed between the circuit board and the sealing plate of the unit cell.

According to a ninth aspect of the present invention, there is provided the battery pack as defined in the first aspect, wherein

the holding member holding the circuit board is a holder that is placed on the sealing plate of the unit cell and holds the circuit board, the holder being made of resin,

the battery pack further comprises an exterior cover that covers the circuit board and the holder and that is fixed to the holder,

the holder includes a bottom wall that is placed on the sealing plate of the unit cell and side walls that are placed on outer periphery of the bottom wall and that hold the circuit board spaced apart from the bottom wall, and

at least part of the bottom wall of the holder is welded and fixed to the unit cell.

According to a tenth aspect of the present invention, there is provided the battery pack as defined in the ninth aspect, wherein thin wall part is formed on the bottom wall of the holder so as to have a wall thickness smaller than those of the other parts, and the bottom wall is welded and fixed to the sealing plate at a site where the thin wall part is formed.

According to an eleventh aspect of the present invention, there is provided the battery pack as defined in the ninth aspect, wherein a skirt is formed by extension of part of the bottom wall of the holder along an outer surface of the battery case, and an outer surface of the battery case and an inner surface of the skirt are welded and fixed to each other.

According to a twelfth aspect of the present invention, there is provided the battery pack as defined in the ninth aspect, wherein

at least one recess or protrusion is formed on an outer surface of the sealing plate of the unit cell,

an engaging part to be engaged with the recess or protrusion of the sealing plate is formed on an outer surface of the bottom wall of the holder, and

the recess or protrusion on the sealing plate and the engaging part on the bottom wall are welded and fixed to each other with both engaged.

According to a 13th aspect of the present invention, there is provided the battery pack as defined in the ninth aspect, wherein

an engaging part to be engaged with an inner surface of the exterior cover is provided on an outer surface of the side wall of the holder, and

the exterior cover is fixed to the holder by engagement of the engaging part.

According to a 14th aspect of the present invention, there is provided the battery pack as defined in the ninth aspect, wherein a protection element is held by the holder.

According to a 15th aspect of the present invention, there is provided the battery pack as defined in the first aspect, wherein a laser permeable part that allows permeation therethrough of laser beam for welding, the laser permeable part being made of resin, is formed in the holder in a position corresponding to region for welding to the unit cell.

According to a 16th aspect of the present invention, there is provided the battery pack as defined in the third aspect, wherein the thin wall part of the exterior cover is formed as a laser permeable part that allows permeation therethrough of laser beam for welding, the laser permeable part being made of resin.

According to a 17th aspect of the present invention, there is provided the battery pack as defined in the ninth aspect, wherein a laser permeable part that allows permeation therethrough of laser beam for welding, the laser permeable part being made of resin, is formed in the bottom wall of the holder, in positions corresponding to regions for welding to the unit cell.

According to the present invention, at least part of the holding member for holding the circuit board is fixed to the unit cell by laser welding, so that the holding member can reliably be fixed to the unit cell. Accordingly, the holder is prevented from easily coming off the unit cell.

In such a fixation structure in which the holding member made of resin and the unit cell made of metal are directly welded by laser welding, the holding member can be fixed to the unit cell with simpler structure than in conventional battery packs in which fixation structures using resin molding are employed. Because of direct welding and fixation between the unit cell and the holding member by laser welding, both can appropriately be fixed with elimination of variation in assembly status of the holding member on the unit cell, and the battery pack stable in geometry and function can be obtained, in comparison with conventional battery packs in which both are mechanically engaged and fixed. Besides, the structure of the battery pack can be simplified all the more and labor for assembly and total cost of the battery pack can be reduced because such increase in number of components as is caused in a configuration having both assembled by screws or the like is avoided and because some labor required for assembly is saved.

### BRIEF DESCRIPTION OF THE DRAWINGS

These aspects and features of the present invention will become clear from the following description taken in conjunction with the preferred embodiments thereof with reference to the accompanying drawings, in which:

FIG. 1 is a vertical front sectional view of a first embodiment of a battery pack according to the invention;

FIG. 2 is an exploded perspective view of the battery pack of the first embodiment;

FIG. 3 is an exploded perspective view of important part of the battery pack of the first embodiment;

FIG. 4 is a vertical side sectional view showing important part of the battery pack of the first embodiment;

FIG. 5 is a front view showing the battery pack on which a label is stuck;

FIG. 6 is an exploded perspective view of important part of a battery pack of a second embodiment;

FIG. 7 is a vertical side sectional view showing important part of the battery pack of the second embodiment;

FIG. 8 is an exploded perspective view of important part of a battery pack of a third embodiment;

FIG. 9 is a vertical side sectional view showing important part of the battery pack of the third embodiment;

FIG. 10 is an exploded perspective view of important part of a battery pack of a fourth embodiment;

FIG. 11 is a vertical side sectional view showing important part of the battery pack of the fourth embodiment;

FIG. 12 is a vertical front sectional view of a battery pack of a fifth embodiment;

FIG. 13 is a perspective view showing important part of a unit cell of the fifth embodiment;

FIG. 14 is an exploded perspective view of important part of the battery pack of the fifth embodiment;

FIG. 15 is a vertical side sectional view showing the important part of the battery pack of the fifth embodiment;

FIG. 16 is a vertical front sectional view of a battery pack of a sixth embodiment;

FIG. 17 is an exploded perspective view of the battery pack of the sixth embodiment;

FIG. 18 is a vertical front sectional view showing important part of the battery pack of the sixth embodiment;

FIG. 19 is a plan view of the important part of the battery pack of the sixth embodiment;

FIG. 20 is an exploded perspective view of important part of the battery pack of the sixth embodiment;

FIG. 21 is a vertical side sectional view of important part of the battery pack of the sixth embodiment;

FIG. 22 is a front view showing the battery pack on which a label is stuck;

FIG. 23 is an exploded perspective view showing important part of a battery pack of a seventh embodiment;

FIG. 24 is a vertical side sectional view of the important part of the battery pack of the seventh embodiment;

FIG. 25 is a vertical front sectional view of a battery pack of an eighth embodiment;

FIG. 26 is an exploded perspective view of the battery pack of the eighth embodiment;

FIG. 27 is a vertical front sectional view showing important part of the battery pack of the eighth embodiment;

FIG. 28 is a plan view of the important part of the battery pack of the eighth embodiment;

FIG. 29 is an exploded perspective view of important part of the battery pack of the eighth embodiment;

FIG. 30 is a vertical side sectional view of the important part of the battery pack of the eighth embodiment;

FIG. 31 is a vertical front sectional view of important part of a battery pack of a ninth embodiment;

FIG. 32 is a vertical front sectional view of a battery pack of a tenth embodiment;

FIG. 33 is an exploded perspective view of the battery pack of the tenth embodiment;

FIG. 34 is an exploded perspective view of important part of the battery pack of the tenth embodiment;

FIG. 35 is a vertical side sectional view showing the important part of the battery pack of the tenth embodiment;

FIG. 36 is a front view showing the battery pack of the tenth embodiment on which a label is stuck;

FIG. 37 is an exploded perspective view of important part of a battery pack of an eleventh embodiment;

FIG. 38 is a vertical side sectional view showing the important part of the battery pack of the eleventh embodiment;

FIG. 39 is a vertical front sectional view of a battery pack of a twelfth embodiment;

FIG. 40 is a perspective view showing important part of a unit cell of the twelfth embodiment;

FIG. 41 is an exploded perspective view of important part of the battery pack of the twelfth embodiment;

FIG. 42 is a vertical side sectional view showing the important part of the battery pack of the twelfth embodiment;

FIG. 43 is an exploded perspective view of important part of a battery pack of a thirteenth embodiment;

FIG. 44 is a vertical side sectional view showing the important part of the battery pack of the thirteenth embodiment;

FIG. 45 is an exploded perspective view of important part of a battery pack of a fourteenth embodiment; and

FIG. 46 is a vertical side sectional view showing the important part of the battery pack of the fourteenth embodiment.

### DETAILED DESCRIPTION OF THE PREFERRED EMBODIMENTS

Before the description of the present invention proceeds, it is to be noted that like parts are designated by like reference numerals throughout the accompanying drawings.

Hereinbelow, embodiments of the invention will be described in detail with reference to the drawings.

### First Embodiment

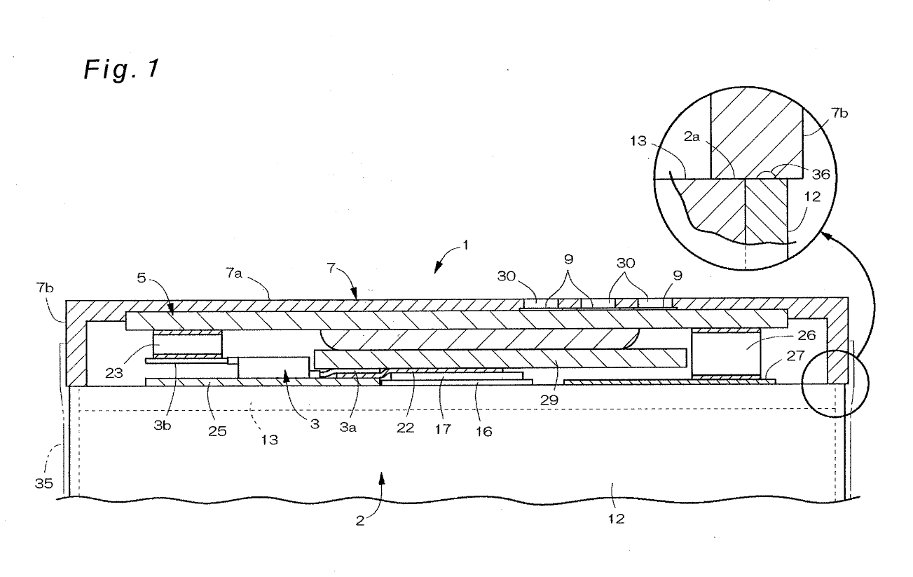

FIGS. 1 through 5 show a first embodiment of a battery pack according to the invention. As shown in FIGS. 1 through 3, a battery pack 1 has a unit cell 2 including a battery case (outer can) 12 having an upper face opening and made of metal and including a sealing plate 13 closing the upper face opening of the battery case 12 and made of metal, a protection element 3 placed above the sealing plate 13, a circuit board 5 placed above the sealing plate 13, and an exterior cover 7 covering the protection element 3 and the circuit board 5 and made of synthetic resin. The protection element 3 is a thermal fuse (PTC) or the like, for instance. Battery packs of the first through fifth embodiments present examples in which a holding member for holding the circuit board is the exterior cover.

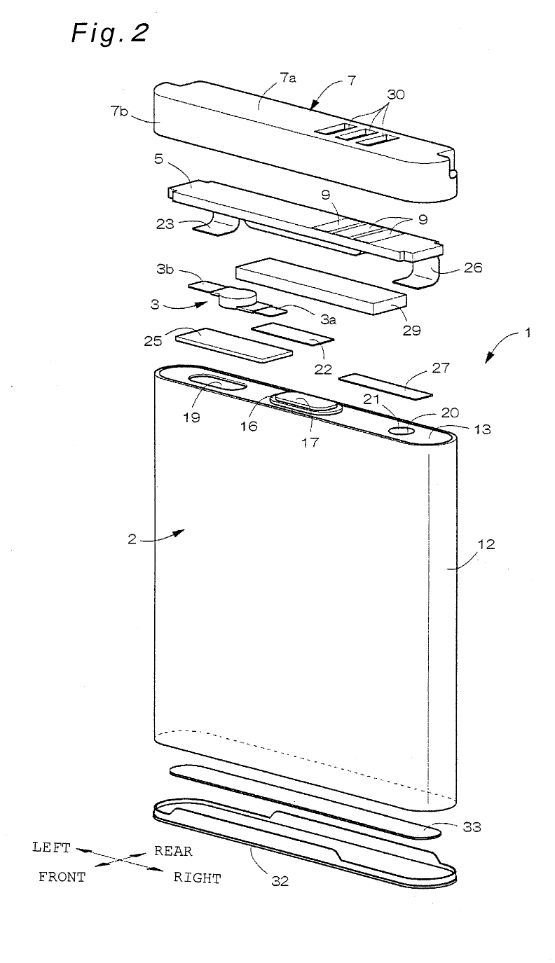

Specifically, the unit cell 2 is a secondary cell such as lithium ion battery that allows discharge and charge thereof and, as shown in FIG. 2, is formed in shape of a flat rectangular parallelopiped having a longitudinal thickness smaller than a vertical height and a lateral width. Three external connection terminals 9 are formed in a row along a lateral direction on a top surface of the circuit board 5, and electronic components that form a protection circuit (safety circuit) and the like are placed on a bottom surface of the circuit board 5. The lateral direction and longitudinal direction with respect to the battery pack 1 are as shown in FIG. 2.

In the unit cell 2, the sealing plate 13 is seam-welded by laser on periphery of the opening of the battery case 12. The battery case 12 is formed by deep drawing of a metal plate made of aluminum or alloy thereof. The sealing plate 13 is formed by press working of a plate made of metal such as aluminum alloy. In the unit cell 2 are enclosed an electrode unit and electrolyte (both are not shown). In the electrode unit, an positive-electrode sheet having LiCoO₂ as positive-electrode active material and a negative-electrode sheet having graphite as negative-electrode active material are coiled like a volute with a separator made of synthetic resin between and the whole unit is flatly shaped. The battery case 12 and the sealing plate 13 may be formed of other metal materials such as stainless material.

At lateral center of the sealing plate 13 of the unit cell 2, a negative terminal 17 is mounted through medium of an insulative packing 16 so as to penetrate the sealing plate 13. The negative terminal 17 is electrically connected to a negative-electrode of the electrode unit in the unit cell 2. Electrical continuity exists also between the battery case 12, the sealing plate 13 and a positive-electrode of the electrode unit in the unit cell 2. On one end side of lateral sides of the sealing plate 13 is formed a cleavage vent 19, which has a function of releasing an internal pressure of the battery by being cloven in case that the internal pressure abnormally increases. On the other end side of the lateral sides of the sealing plate 13 is formed a liquid injection hole 20 through which nonaqueous electrolyte is to be injected into the unit cell 2. After the electrolyte is injected, the liquid injection hole 20 is closed by a sealing plug 21 and is sealed by laser.

One connection terminal 3a of the protection element 3 is connected through a thin lead plate 22 to a top surface of the negative terminal 17 of the unit cell 2, and the other connection terminal 3b of the protection element 3 is connected to a negative lead 23 shaped like a thin plate that is provided on one end side of lateral sides on a bottom surface of the circuit board 5. Each of the connection terminals 3a and 3b of the protection element 3 is formed of a nickel plate or the like. Between the protection element 3 and the sealing plate 13 of the unit cell 2 is placed an insulating plate 25 made of synthetic resin, which insulates the protection element 3 from the sealing plate 13 and holds the element.

A positive lead 26 shaped like a thin plate that is provided on the other end side of the lateral sides on the bottom surface of the circuit board 5 is connected to the sealing plate 13 of the unit cell 2 through a clad plate 27 formed of aluminum and nickel. Each of the positive and negative leads 23 and 26 of the circuit board 5 is formed of a nickel plate or the like. The positive lead 26 may directly be connected to the sealing plate 13 of the unit cell 2. Between the circuit board 5 and the sealing plate 13 of the unit cell 2 is placed a plate-like holder 29 made of synthetic resin, through which the circuit board 5 is held on the sealing plate 13 of the unit cell 2.

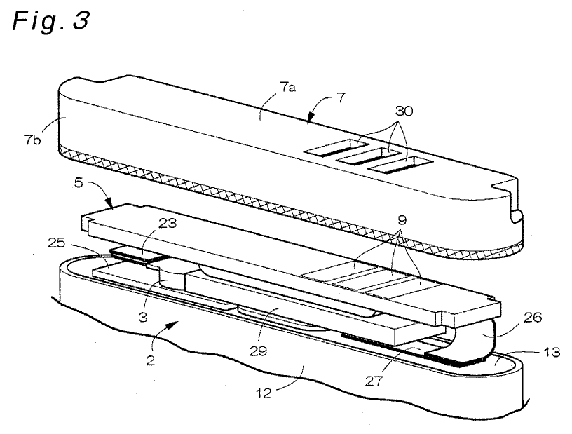

The exterior cover 7 includes a top wall 7a and a peripheral side wall 7b extending downward from an outer periphery of the top wall 7a. The exterior cover 7 is formed by injection molding from resin material such as polycarbonate (PC), polyamide (PA), polyethylene terephthalate (PET) or polypropylene (PP), that is, from synthetic resin material. On the top wall 7a of the exterior cover 7, as shown in FIGS. 1 and 3, three windows 30 are formed at locations corresponding to the external connection terminals 9 of the circuit board 5. Thus the external connection terminals 9 of the circuit board 5 are exposed on an outer surface of the battery pack 1 through the windows 30 of the exterior cover 7, so that contact of connection terminals (not shown) of external equipment with the external connection terminals 9 allows input and output of charge and discharge currents into and from the unit cell 2. A thickness of the exterior cover 7 is defined on the order of 0.4 to 0.5 mm, for instance.

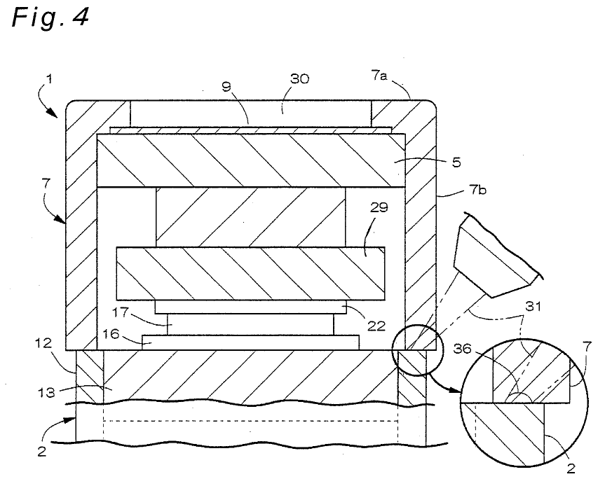

At least part of a lower end portion of the peripheral side wall 7b of the exterior cover 7 (that is, an opening edge of the exterior cover 7) is welded and fixed onto a peripheral edge portion of a top face 2a of the unit cell 2 by laser welding, e.g., with use of YAG laser. As shown in FIG. 4, a YAG laser beam 31 is applied from a diagonally above direction toward a close contact part between a lower end face of the peripheral side wall (outer surface) 7b of the exterior cover 7 and the peripheral edge portion of the top face 2a of the unit cell 2. Thus a portion 36 irradiated with the YAG laser beam 31 is molten in the close contact part between the lower end part of the peripheral side wall 7b of the exterior cover 7 and the peripheral edge portion of the top face 2a of the unit cell 2, and the exterior cover 7 is thereby welded onto the peripheral edge portion of the top face 2a of the unit cell 2. That is, the portion 36 is molten by the YAG laser beam 31, and a portion of the molten resin enters minute depressions and projections of metal on the top face 2a of the unit cell 2 and is then solidified, so that the peripheral side wall 7b of the exterior cover 7 is fixed to the peripheral edge portion of the top face 2a of the unit cell 2 by anchor effect and the like. A method of such joining between resin material and metal material with use of laser beam is disclosed in WO2007/029440, for example.

The whole lower end face of the peripheral side wall 7b of the exterior cover 7 may be welded onto the peripheral edge portion of the top face 2a of the unit cell 2 by the YAG laser beam 31 or the lower end face of the peripheral side wall 7b of the exterior cover 7 may be welded at specified intervals along the peripheral edge portion of the top face 2a of the unit cell 2 by the YAG laser beam 31. That is, at least part of the lower end face of the peripheral side wall 7b of the exterior cover 7 has only to be laser-welded onto the top face 2a of the unit cell 2. A wavelength of the YAG laser beam 31 used for such laser welding is set at 1064 nm and an output thereof is set between 75 and 1500 W, for instance.

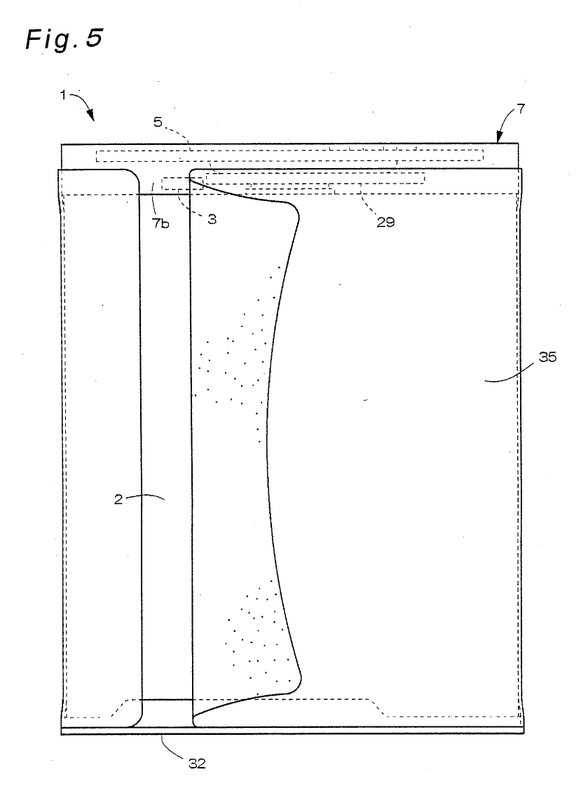

Onto a bottom surface of the unit cell 2, a bottom cover 32 made of synthetic resin is stuck and fixed by a double-sided adhesive tape 33. As shown in FIG. 5, a label 35 composed of an insulative sheet or the like is stuck on an outer wall surface of the unit cell 2 and on lower part of the peripheral side wall 7b of the exterior cover 7. The bottom cover 32 may be fixed to the bottom surface of the unit cell 2 by laser welding. Provided that such laser welding is employed, the double-sided adhesive tape 33 is omitted.

Hereinbelow will be described a procedure for assembling the battery pack 1 having such a configuration. Initially, the one connection terminal 3a of the protection element 3 is connected to one end side of the lead plate 22 by spot welding or the like, and the other end side of the lead plate 22 is connected to the top surface of the negative terminal 17 of the unit cell 2 by spot welding or the like. On this occasion, the insulating plate 25 is placed on top of the sealing plate 13 of the unit cell 2, and the protection element 3 is placed on top of the insulating plate 25. Before being assembled, the leads 23 and 26 of the circuit board 5 are not bent but extend straight in one of the longitudinal directions from lateral end parts of the circuit board 5.

The clad plate 27 is connected to the sealing plate 13 of the unit cell 2 by spot welding or the like, and an extremity of the positive lead 26 of the circuit board 5 is connected to the clad plate 27 by spot welding or the like. Subsequently, an extremity of the negative lead 23 of the circuit board 5 is connected to the other connection terminal 3b of the protection element 3 by spot welding or the like. After the holder 29 is placed in a specified position on top of the sealing plate 13 of the unit cell 2, both the leads 23 and 26 of the circuit board 5 are bent and the circuit board 5 is placed on the holder 29 (a state of FIG. 3).

After that, the exterior cover 7 is put over the protection element 3 and the circuit board 5, in a posture in which the windows 30 of the exterior cover 7 are placed so as to correspond to the external connection terminals 9 of the circuit board 5, and the lower end of the peripheral side wall 7b of the exterior cover 7 is brought into contact with the peripheral edge portion of the top face 2a of the unit cell 2. In this state, the YAG laser beam 31 is applied from the diagonally above direction toward the close contact part (joint surface) between the lower end face of the peripheral side wall 7b of the exterior cover 7 and the peripheral edge portion of the top face 2a of the unit cell 2, so that energy of the laser beam is concentrated on the close contact part. By the application of the laser beam, the portion 36 of the exterior cover 7 in the close contact part is molten, and the peripheral side wall 7b of the exterior cover 7 is fixed to the peripheral edge portion of the top face 2a of the unit cell 2 by laser welding. Thus the battery pack 1 is finished. Then the label 35 is stuck on the finished battery pack 1, so that the outer wall surface of the unit cell 2 and the lower part of the peripheral side wall 7b of the exterior cover 7 are covered with the label 35.

In this manner, the lower end portion of the peripheral side wall 7b of the exterior cover 7 is fixed to the peripheral edge portion of the top face 2a of the unit cell 2 by laser welding, therefore the exterior cover 7 is reliably fixed to the unit cell 2 and the exterior cover 7 is reliably prevented from coming off the unit cell 2 as a result of small impact or the like. Consequently, the protection element 3 and the circuit board 5 can reliably be protected by the exterior cover 7.

In such a fixation structure in which the exterior cover 7 made of synthetic resin and the outer metal wall surface of the unit cell 2 are directly welded by laser welding, the exterior cover 7 can reliably be fixed to the unit cell 2 with simpler structure than in a conventional battery pack in which the exterior cover 7 is fixed to the unit cell 2 by resin molding. Because of direct welding and fixation between the unit cell 2 and the exterior cover 7 by laser welding, both can appropriately be fixed with reduction in variation in assembly status of the exterior cover 7 on the unit cell 2, and the battery pack 1 stable in geometry and function can be obtained, in comparison with conventional battery packs in which both are mechanically engaged and fixed. Besides, the structure of the battery pack 1 can be simplified all the more and labor for assembly and total cost of the battery pack 1 can be reduced because such increase in number of components as is caused in a configuration having both assembled by screws or the like is avoided and because some labor required for assembly is saved.

### Second Embodiment

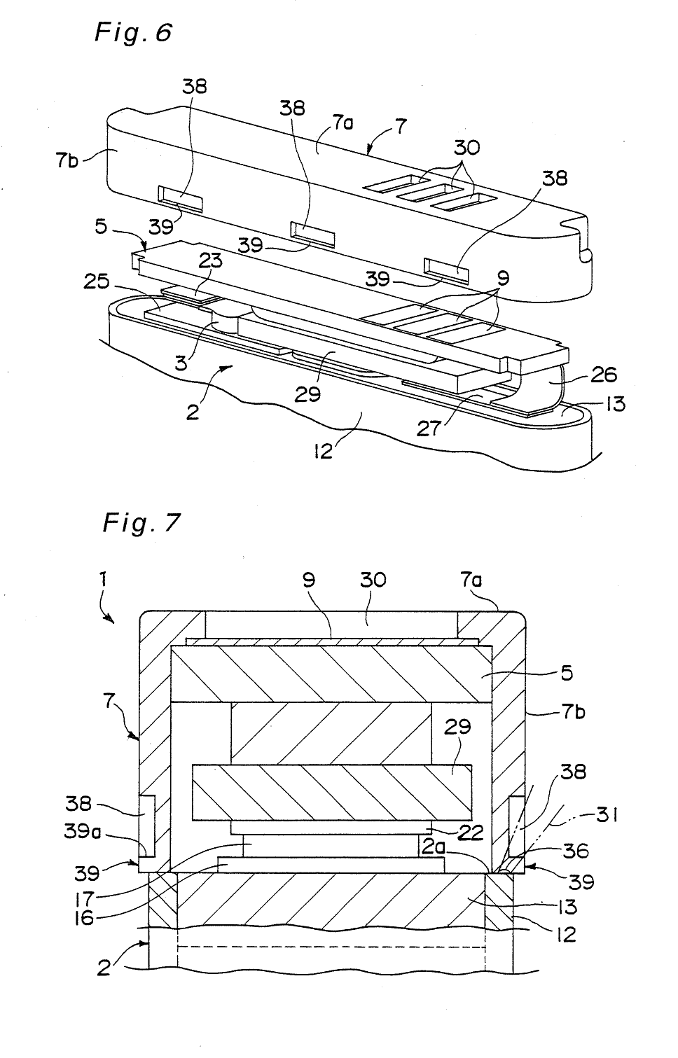

FIGS. 6 and 7 show a second embodiment of a battery pack according to the invention. The second embodiment is different from the first embodiment in that a YAG laser beam 31 is applied with utilization of recessed thin wall parts formed partially on outer periphery of a lower end (opening edge) of a peripheral side wall 7b of an exterior cover 7.

As shown in FIGS. 6 and 7, a plurality of recesses 38 placed circumferentially are formed on the outer periphery of the lower end of the peripheral side wall 7b of the exterior cover 7, and the thin wall parts 39 are formed between lower surfaces of inner periphery, in the drawing, of the recesses 38 and the lower end face of the peripheral side wall 7b of the exterior cover 7. In the thin wall parts 39, top surfaces thereof in the drawing (i.e., the lower surfaces of inner periphery, in the drawing, of the recesses 38) are formed as flat parts (flat surfaces) 39a placed generally in parallel with a top face 2a of a unit cell 2. Bottom surfaces of the thin wall parts 39 in the drawing form the lower end face of the peripheral side wall 7b of the exterior cover 7 and are placed in close contact with the peripheral edge portion of the top face 2a of the unit cell 2.

A thickness of the thin wall parts 39 is set so that a distance from centers of the close contact parts (welding region) between the bottom surfaces of the thin wall parts 39 and the peripheral edge portion of the top face 2a of the unit cell 2 to the outer surface of the exterior cover 7, i.e., the distance to the flat parts 39a of the thin wall parts 39 is smaller than distances between outer and inner surfaces of the other parts of the exterior cover 7.

In the second embodiment, as shown in FIG. 7, the YAG laser beam 31 is applied from above toward the flat part 39a of the thin wall part 39 of the exterior cover 7, with the exterior cover 7 put over a protection element 3 and a circuit board 5 and with the lower face of the exterior cover 7 being in close contact with the peripheral edge portion of the top face 2a of the unit cell 2. Specifically, the YAG laser beam 31 is applied from an angle inclined with respect to a vertical direction in the drawing so that the YAG laser beam 31 applied toward the flat part 39a of the thin wall part 39 passes through the thin wall part 39 and so that energy of the laser beam is concentrated on the close contact part (welding region) between the bottom surface of the thin wall part 39 and the top face 2a of the unit cell 2. Thus a portion 36 irradiated with the YAG laser beam 31 is molten in the close contact part between the bottom surface side of the thin wall part 39 of the exterior cover 7 and the peripheral edge portion of the top face 2a of the unit cell 2, and the exterior cover 7 is thereby welded onto the peripheral edge portion of the top face 2a of the unit cell 2. That is, the bottom surface side of the thin wall parts 39 of the exterior cover 7 is fixed to the peripheral edge portion of the top face 2a of the unit cell 2 by laser welding.

The vertical thickness of the thin wall parts 39 is defined on the order of 0.1 to 0.15 mm, for instance. Other points are the same as those of the first embodiment and description thereof is therefore omitted. In the bottom surface side of the thin wall parts 39 is included bottom surface part of the exterior cover 7 that is inside the thin wall parts 39 with respect to the exterior cover 7. The thin wall parts 39 may be formed on whole circumference of the peripheral side wall 7b of the exterior cover 7.

In such a fixation structure in which the top face 2a of the unit cell 2 and the bottom surface side of the thin wall parts 39 of the exterior cover 7 in close contact with the top face are welded and fixed by laser welding, the laser beam 31 can be applied at an angle nearly perpendicular to the flat parts (top surfaces) 39a of the thin wall parts 39 of the exterior cover 7. Thus energy of the laser beam 31 can reliably be concentrated on the close contact part (which is to form a welding surface or welding region) between the bottom surface side of the thin wall parts 39 and the top face 2a of the unit cell 2, so that reduction of occurrence of poor welding and reliable fixation of the exterior cover 7 to the unit cell 2 can be attained.

### Third Embodiment

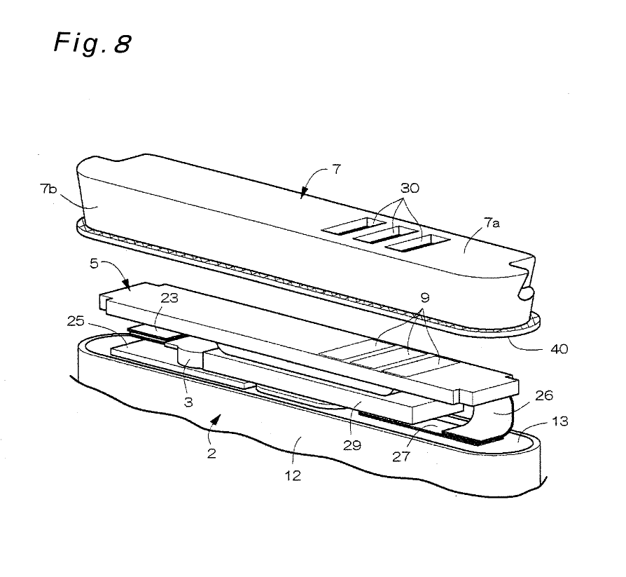

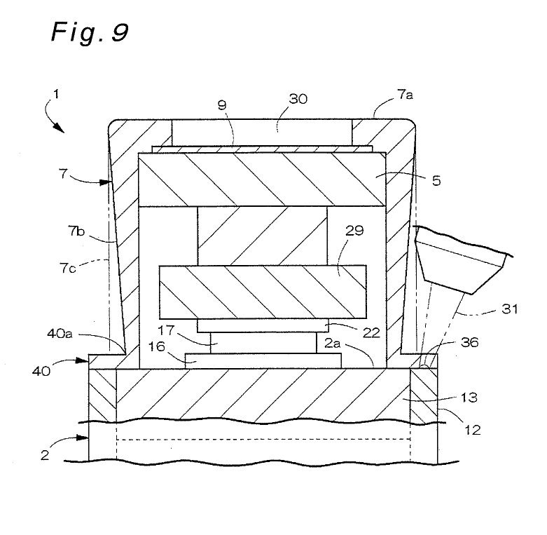

FIGS. 8 and 9 show a third embodiment of a battery pack according to the invention. In the third embodiment, a flange 40 protruding horizontally outward in the drawings is formed on outer periphery of a lower end of a peripheral side wall 7b of an exterior cover 7. In the flange 40, as shown in FIG. 9, a base end 40a of protrusion from the peripheral side wall 7b of the exterior cover 7 is positioned closer to inside of the exterior cover 7 than a reference surface 7c defined by an external shape of a top wall 7a of the exterior cover 7. Specifically, thicknesses of the peripheral side wall 7b are made the smaller at the lower position in the drawing, and thus an outer wall surface of the peripheral side wall 7b is made a slant surface that is positioned the closer to inside of the exterior cover 7 at the lower position in the drawing.

In the flange 40, a top surface (flat surface) thereof in the drawing that continues from the outer surface of the peripheral side wall 7b of the exterior cover 7 and a bottom surface thereof that continues from an inner surface of the side wall are placed generally in parallel with a top face 2a of a unit cell 2. Furthermore, a thickness of the flange 40 is set so that a distance from a center of close contact part (which is to form a welding surface or welding region) between the bottom surface of the flange 40 and a peripheral edge portion of the top face 2a of the unit cell 2 to the top surface of the flange 40 is smaller than distances between the outer and inner surfaces of the other parts of the exterior cover 7.

In the third embodiment, as shown in FIG. 9, a YAG laser beam 31 is applied from above toward the top surface of the flange 40 of the exterior cover 7, with the exterior cover 7 put over a protection element 3 and a circuit board 5 and with the bottom surface of the flange 40 being in close contact with the peripheral edge portion of the top face 2a of the unit cell 2. Thus a portion 36 irradiated with the YAG laser beam 31 is molten in the close contact part between the bottom surface of the flange 40 of the exterior cover 7 and the peripheral edge portion of the top face 2a of the unit cell 2, and the exterior cover 7 is thereby welded onto the peripheral edge portion of the top face 2a of the unit cell 2. That is, the bottom surface of the flange 40 of the exterior cover 7 is fixed to the peripheral edge portion of the top face 2a of the unit cell 2 by laser welding. A vertical thickness of the flange 40 is defined on the order of 0.1 to 0.15 mm, for instance. Other points are the same as those of the first embodiment and description thereof is therefore omitted.

In the third embodiment, the YAG laser beam 31 can be applied at an angle nearly perpendicular to the top surface of the flange 40 of the exterior cover 7. Thus energy of the laser beam 31 can effectively be concentrated on the close contact part between the bottom surface of the flange 40 and the peripheral edge portion of the top face 2a of the unit cell 2, so that reduction of occurrence of poor welding and reliable welding of the exterior cover 7 to the unit cell 2 can be attained. Besides, the protrusion base end 40a of the flange 40 that is positioned with deviation toward inside of the exterior cover 7 increases an area of the top surface of the flange 40, so that the YAG laser beam 31 can reliably be applied to the top surface of the flange 40.

The outer wall surface of the peripheral side wall 7b that is formed of the slant surface prevents interference between an emission unit of the YAG laser beam 31 and the peripheral side wall 7b and allows the YAG laser beam 31 to be applied from positions closer to the flange 40. It is also advantageous that the formation of the slant surface on the outer wall surface side of the peripheral side wall 7b avoids decrease in inner volume of the exterior cover 7 which might be caused by the provision of the slant surface and thus avoids impairment in a space for accommodating items to be accommodated such as the protection element 3.

The flange 40 may be formed on whole circumference of the peripheral side wall 7b of the exterior cover 7, as shown in FIG. 8, or may be formed only on some parts of the circumference of the peripheral side wall 7b of the exterior cover 7. The outer wall surface of the peripheral side wall 7b of the exterior cover 7 may be slanted as a whole, as shown in FIG. 9, or only lower part thereof may be slanted.

### Fourth Embodiment

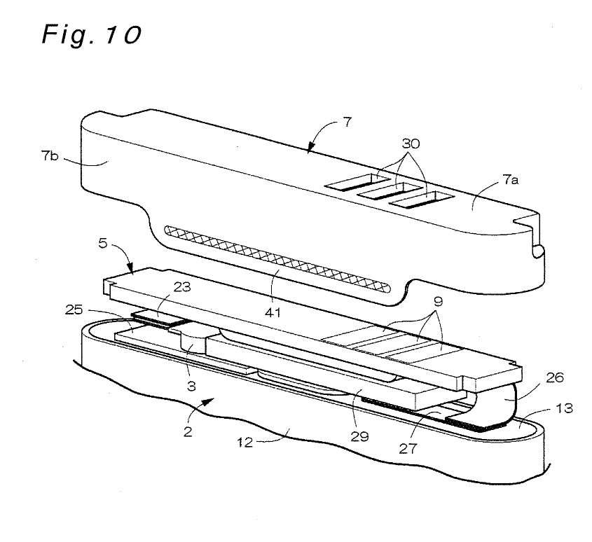

FIGS. 10 and 11 show a fourth embodiment of a battery pack according to the invention. In the fourth embodiment, as shown in FIG. 11, front and rear parts of a lower end portion of a peripheral side wall 7b of an exterior cover 7 are extended to lower positions than a top face 2a of a unit cell 2 so as to form skirts 41. In the fourth embodiment, the skirts 41 are an example of thin wall parts and have thicknesses that are defined so as to be smaller than thicknesses of the other parts of the exterior cover 7, e.g., so as to be on the order of 0.1 to 0.15 mm.

As shown in FIG. 11, a YAG laser beam 31 is applied from a front or rear direction toward each of the skirts 41 of the exterior cover 7, with the exterior cover 7 put over a protection element 3 and a circuit board 5 and with inner wall surfaces of the skirts 41 being in close contact with an outer wall surface of a battery case 12 of the unit cell 2. Thus a portion 36 irradiated with the YAG laser beam 31 is molten in an close contact part between the inner wall surface of the skirt 41 of the exterior cover 7 and the outer wall surface of the battery case 12 of the unit cell 2, and the inner wall surface of each skirt 41 is thereby welded onto the outer wall surface of the battery case 12. That is, the skirts 41 of the exterior cover 7 are fixed to the outer wall surface of the unit cell 2 by laser welding. Other points are the same as those of the first embodiment and description thereof is therefore omitted.

In such a fixation structure of the fourth embodiment in which the outer wall surface of the battery case 12 and the inner wall surfaces of the skirts 41 in close contact with the outer wall surface are welded by laser welding for fixation of the exterior cover 7 to the unit cell 2, the laser beam 31 can be applied from transverse directions (i.e., horizontal directions in the drawing) to the skirts 41 of the exterior cover 7, and the skirts 41 can thereby be welded onto the battery case 12 of the unit cell 2. Consequently, laser welding can easily be performed without obstruction of the exterior cover 7 in laser welding.

### Fifth Embodiment

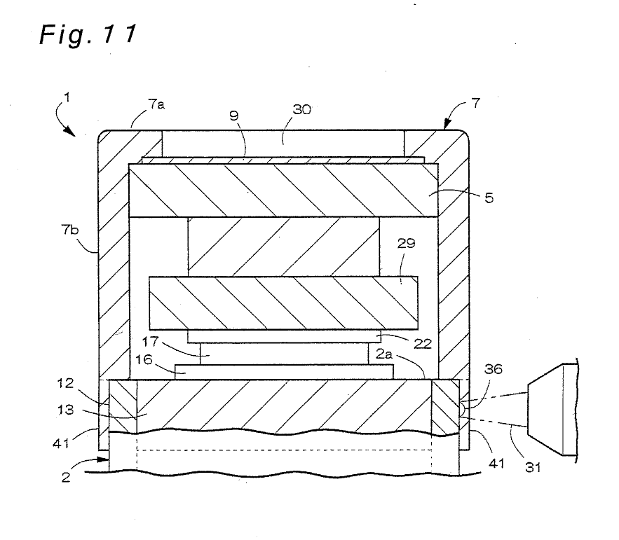

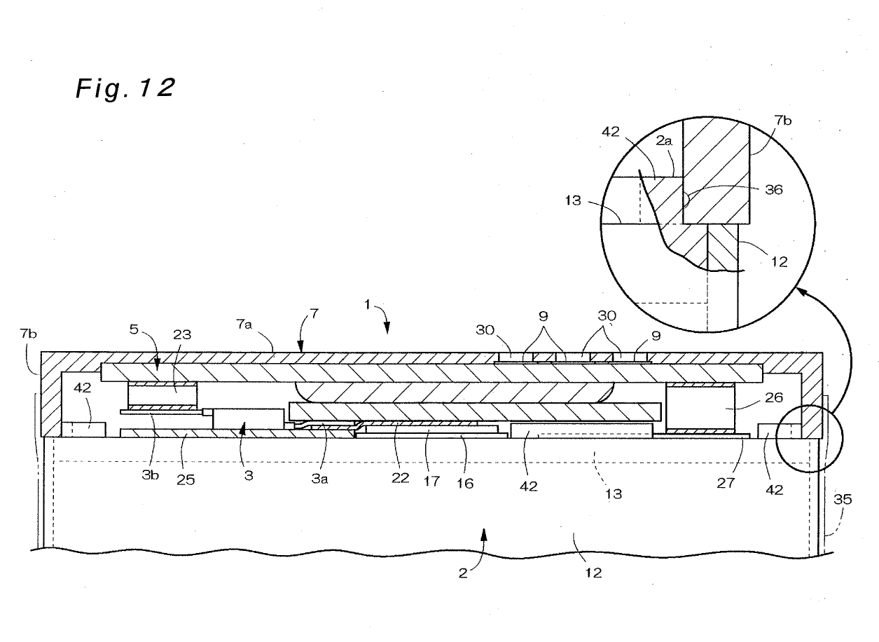

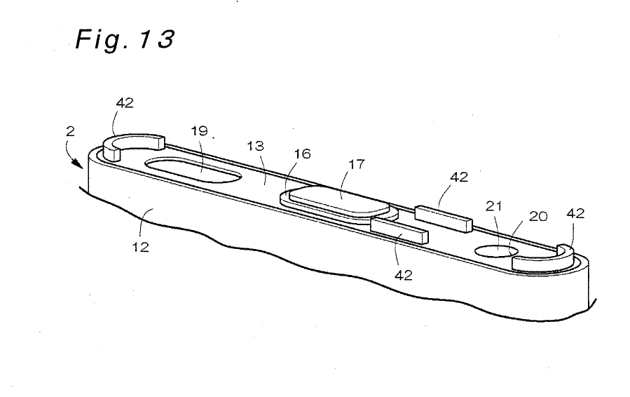

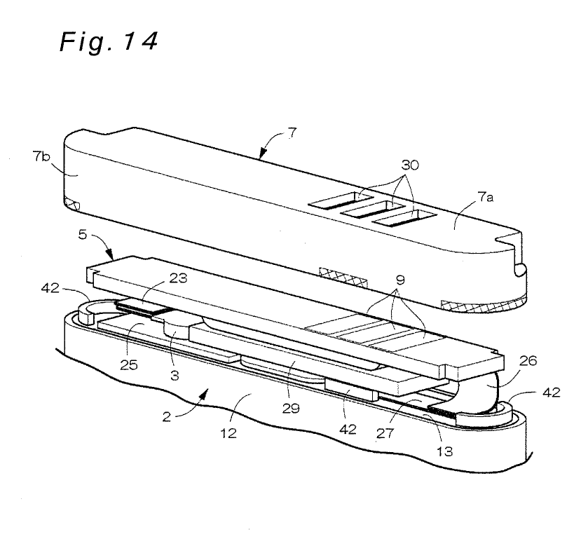

FIGS. 12 through 15 show a fifth embodiment of a battery pack according to the invention. In the fifth embodiment, as shown in FIGS. 13 and 14, four welding protrusions 42 are formed so as to protrude upward, in the drawings, on a top surface of a sealing plate 13 of a unit cell 2. The welding protrusions 42 are placed along periphery of the sealing plate 13. That is, on the top surface of the sealing plate 13 of the unit cell 2, two welding protrusions 42 are formed in shape of circular arcs along left and right circular peripheral parts of the sealing plate 13, and two welding protrusions 42 are formed in a linear shape along front and rear linear peripheral parts of the sealing plate 13.

As shown in FIGS. 12 and 15, a YAG laser beam 31 is applied from a transverse direction to a peripheral side wall 7b of an exterior cover 7, with the exterior cover 7 put over a protection element 3 and a circuit board 5 and with an inner surface of the peripheral side wall 7b of the exterior cover 7 being in close contact with outer surfaces of the welding protrusions 42. Thus a portion 36 irradiated with the YAG laser beam 31 is molten in an close contact part between an inner wall surface of a lower end portion of the exterior cover 7 and the outer wall surface of the welding protrusion 42 of the unit cell 2, and welding onto the welding protrusion 42 of the unit cell 2 is thereby performed. That is, the inner wall surface of the lower end portion of the exterior cover 7 is fixed, by laser welding, to the outer wall surface of the welding protrusion 42 of the unit cell 2. Other points are the same as those of the first embodiment and description thereof is therefore omitted.

In such a fixation structure of the fifth embodiment in which the outer wall surfaces of the welding protrusions 42 and the inner wall surface of the exterior cover 7 in close contact with the outer wall surfaces are welded by laser welding for fixation of the exterior cover 7 to the unit cell 2, the welding protrusions 42 prevent the exterior cover 7 from moving in transverse directions by influence of impact or the like. Consequently, strength of the exterior cover 7 in the transverse directions can be increased. Besides, the exterior cover 7 can be welded to the unit cell 2 by the application of the laser beam 31 from the transverse directions relative to the exterior cover 7, and thus laser welding can easily be performed without obstruction of the exterior cover 7 in laser welding.

In the battery packs 1 of the first through fifth embodiments, the holder 29 made of synthetic resin is placed between the circuit board 5 and the sealing plate 13 of the unit cell 2, so that shake of the circuit board 5 in the exterior cover 7 is reduced by support of the circuit board 5 by the holder 29. Consequently, the circuit board 5 can be prevented from being rubbed and damaged by the inner surface of the exterior cover 7 or the like.

### Sixth Embodiment

FIGS. 16 through 22 show a sixth embodiment of a battery pack according to the invention. As shown in FIGS. 16 and 16, a battery pack 101 has a unit cell 102 including a battery case 112 having an upper face opening and made of metal and including a sealing plate 113 closing the upper face opening of the battery case 112 and made of metal, a protection element 103 composed of a thermal fuse (PTC) or the like, a circuit board 105 having a safety circuit such as a protection circuit, a holder 106 that is placed on a top face of the unit cell 102 for holding the protection element 103, the circuit board 105 and the like and that is made of resin (e.g., synthetic resin), and an exterior cover 107 that is attached to the holder 106 while covering the circuit board 105, the holder (board holder) 106 and the like and that is made of resin (e.g., synthetic resin). Battery packs of the sixth through ninth embodiments present examples in which a holding member for holding the circuit board is the holder.

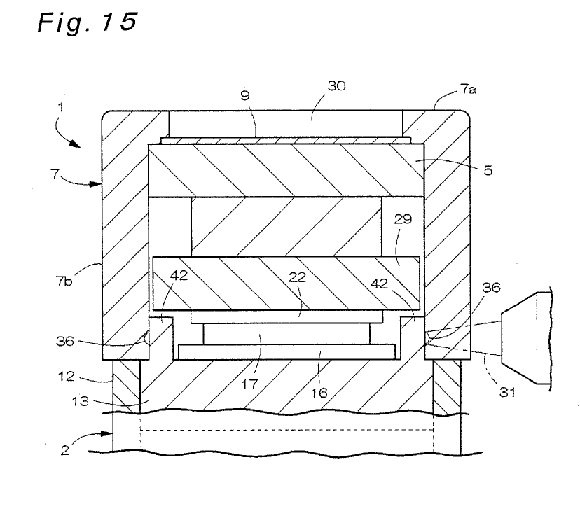

Specifically, the unit cell 102 is a secondary cell such as lithium ion battery that allows discharge and charge thereof and, as shown in FIG. 17, is formed in shape of a flat rectangular parallelopiped having a longitudinal thickness smaller than a vertical height and a lateral width. Three external connection terminals 109 are formed in a row along a lateral direction on a top surface of the circuit board 105, and electronic components that form the protection circuit (safety circuit) and the like are placed on a bottom surface of the circuit board 105. The electronic components that form the protection circuit are covered with resin.

In the unit cell 102, the sealing plate 113 is seam-welded by laser onto periphery of the opening of the battery case 112. The battery case 112 is formed by deep drawing of a metal plate made of aluminum or alloy thereof. The sealing plate 113 is formed by press working of a plate made of metal such as aluminum alloy. In the unit cell 102 are enclosed an electrode unit and electrolyte (both are not shown). In the electrode unit, an positive-electrode sheet having LiCoO₂ as positive active material and a negative-electrode sheet having graphite as negative-electrode active material are coiled like a volute with a separator made of synthetic resin between and the whole unit is flatly shaped.

At lateral center of the sealing plate 113 of the unit cell 102, a negative terminal 117 is mounted through medium of an insulative packing 116 so as to pierce the sealing plate 113. The negative terminal 117 is electrically connected to a negative-electrode of the electrode unit in the unit cell 102. Electrical continuity exists also between the battery case 112, the sealing plate 113 and the positive-electrode of the electrode unit in the unit cell 102. On one end side (left side in FIG. 17) of lateral sides of the sealing plate 113 is formed a cleavage vent 119, which has a function of releasing an internal pressure of the battery by being cloven in case that the internal pressure abnormally increases. On the other end side (right side in FIG. 17) of the lateral sides of the sealing plate 113 is formed a liquid injection hole 120 through which nonaqueous electrolyte is to be injected into the unit cell 102. After the electrolyte is injected, the liquid injection hole 120 is closed by a sealing plug 121 and is sealed by laser.

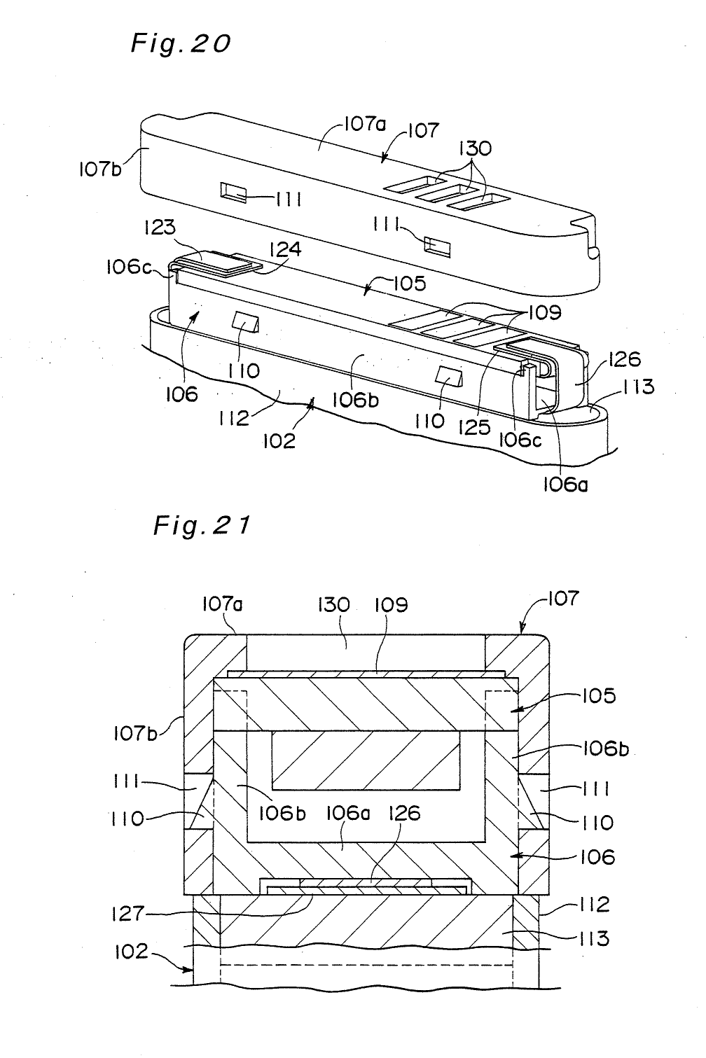

As shown in FIGS. 16 and 17, the holder 106 has a laterally oblong bottom wall 106a that faces the sealing plate 113 being the top face of the unit cell 102 and a pair of front and rear side walls 106b, 106b protruding upward from front and rear peripheries of the bottom wall 106a. The holder 106 is formed by injection molding from resin material such as polycarbonate (PC), polyamide (PA), polyethylene terephthalate (PET) or polypropylene (PP), that is, from synthetic resin material. From each of both lateral ends of upper ends of the side walls 106b of the holder 106 is protruded a protrusion 106c. Cutouts 105a formed in front and rear positions at lateral ends of the circuit board 105 are respectively engaged with the protrusions 106c of the holder 106, so that the circuit board 105 is held while being received by the upper ends of the side walls 106b, 106b of the holder 106 (see FIG. 20). On one lateral end side (left side in FIG. 16) of the bottom wall 106a of the holder 106 is placed and held a protection element 103.

A pair of left and right pawls 110, 110 are formed on and protruded outward from each of outer surfaces of the side walls 106b of the holder 106, as shown in FIGS. 20 and 21, and the pawls 110 are respectively engaged with engagement holes 111 formed in front and rear positions on a peripheral side wall 107b of the exterior cover 107. Thus the exterior cover 107 is fastened to the holder 106 so as not to be easily released (a state in FIG. 21). An outer surface of each pawl 110 is a surface slanted outward along a downward direction.

One connection terminal 103a of the protection element 103 is connected through a thin lead plate 122 to a top surface of the negative terminal 117 of the unit cell 102, as shown in FIG. 16, and the other connection terminal 103b of the protection element 103 is connected to a negative lead 123 shaped like a thin plate. The negative lead 123 is connected to a negative connector 124 that is placed at one of the lateral ends (on left side in FIG. 16) of the circuit board 105 and that is shaped like a thin plate. The negative connector 124 is bent into shape of a letter U in order to pinch the one end of the circuit board 105 from above and below, and a lower side of the negative connector 124 is connected to a negative terminal 105b (FIG. 17) of the circuit board 105. An upper side of the negative connector 124 is connected to the negative lead 123.

At the other end (on right side in FIG. 16) of the circuit board 15 is placed a positive connector 125 that is shaped like a thin plate. The positive connector 125 is bent into shape of a letter U in order to pinch the other end of the circuit board 105 from above and below, and a lower side of the positive connector 125 is connected to an positive terminal 105c (FIG. 17) of the circuit board 105. An upper side of the positive connector 125 is connected to an upper end side of a positive lead 126 that is shaped like a thin plate, and a lower end side of the positive lead 126 is connected to the sealing plate 113 of the unit cell 102 through a clad plate 127 composed of aluminum and nickel. Each of the connection terminals 103a, 103b of the protection element 103, the positive and negative leads 123, 126, and the positive and negative connectors 124, 125 is composed of a nickel plate or the like. The positive lead 126 may directly be connected to the sealing plate 113 of the unit cell 102.

As shown in FIGS. 16 and 17, the exterior cover 107 includes a top wall 107a and the peripheral side wall 107b extending downward from an outer periphery of the top wall 107a, and is shaped like a box opening on a bottom face. The exterior cover 107 is formed by injection molding from resin material such as polycarbonate (PC), polyamide (PA), polyethylene terephthalate (PET) or polypropylene (PP), that is, from synthetic resin material. On the top wall 107a of the exterior cover 107, three windows 130 are formed at locations corresponding to external connection terminals 109 of the circuit board 105. Thus the external connection terminals 109 are exposed on an outer surface of the battery pack 101 through the windows 130 of the exterior cover 107, so that contact of connection terminals (not shown) of external equipment with the external connection terminals 109 allows input and output of charge and discharge currents into and from the unit cell 102.

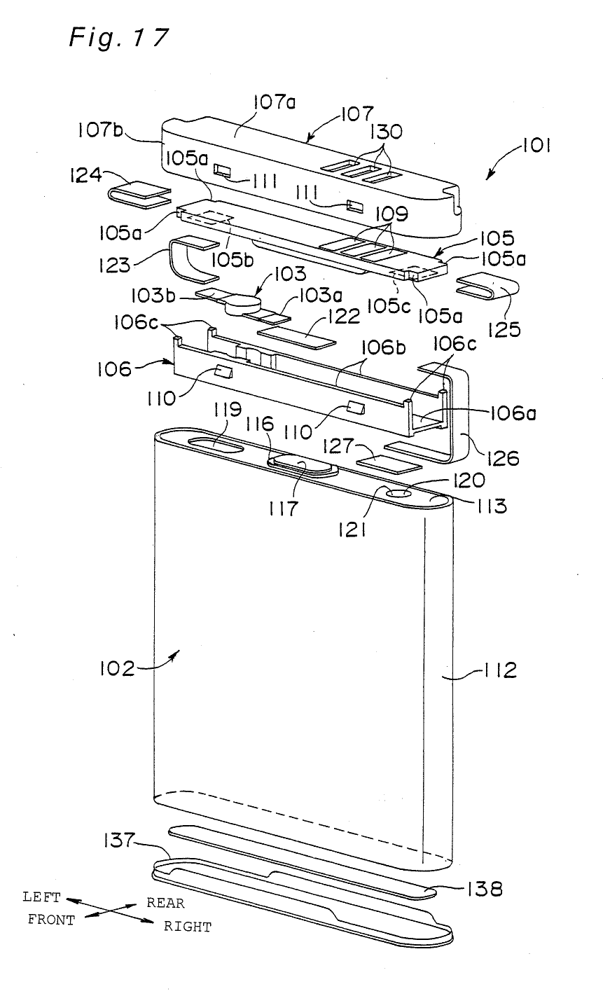

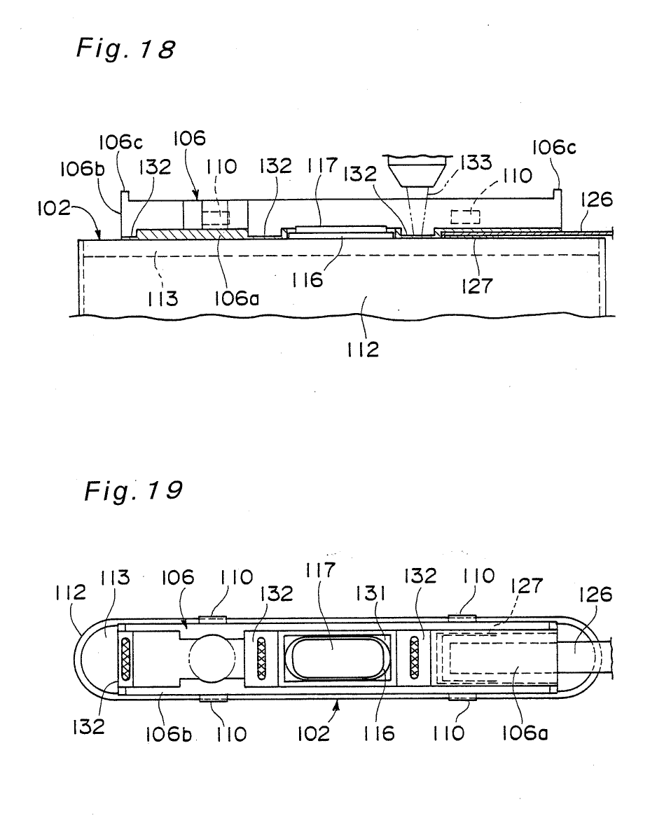

On lateral center part of the bottom wall 106a of the holder 106, as shown in FIGS. 16 and 19, an insertion hole 131 is formed into which the negative terminal 117 and the insulative packing 116 of the unit cell 102 are inserted. On the bottom wall 106a of the holder 106, upper surface side on both left and right sides of the insertion hole 131 is recessed so as to form thin wall parts 132, 132. On the bottom wall 106a of the holder 106, upper surface side of one end part (left side in FIG. 16) thereof is recessed so as to form a thin wall part 132. On the holder 106, at least lower faces of the thin wall parts 132 are in contact with the top face of the unit cell 102. In the holder 106, vertical thicknesses of the thin wall parts 132 are defined so as to be smaller than thicknesses of the other parts, e.g., so as to be on the order of 0.1 to 0.15 mm. A clearance for passage of the positive lead 126 is formed on lower surface side of the other end part (right side in FIG. 16) of the bottom wall 106a of the holder 106.

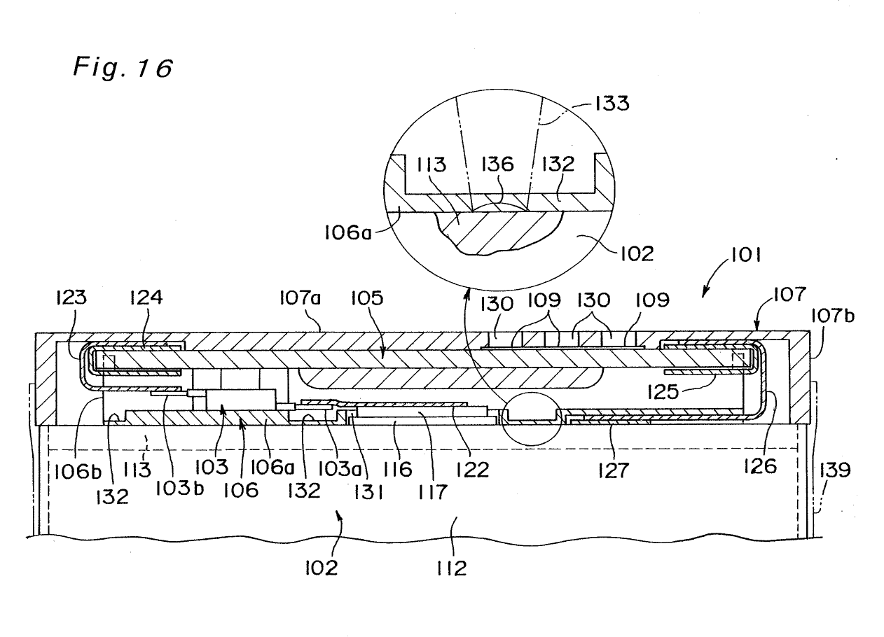

In the holder 106, the thin wall parts 132 of the bottom wall 106a are fixed onto the top face of the unit cell 102 by laser welding with use of YAG laser beam 131, for instance. As shown in FIG. 18, the YAG laser beam 133 is applied from above perpendicularly in general to the thin wall part 132 of the bottom wall 106a of the holder 106. As shown in FIG. 16, a portion 136 irradiated with the YAG laser beam 133 is molten in a contact part between the thin wall part 132 of the bottom wall 106a and the top face of the unit cell 102, and the holder 106 is thereby welded onto the top face of the unit cell 102. That is, the portion 136 is molten by the YAG laser beam 133, and a portion of the molten resin enters minute depressions and projections of metal on the top face of the unit cell 102 and is then solidified, so that the bottom wall 106a of the holder 106 is fixed to the top face of the unit cell 102 by anchor effect and the like. A wavelength of the YAG laser beam 133 used for such laser welding is set at 1064 nm and an output thereof is set between 75 and 1500 W, for instance.

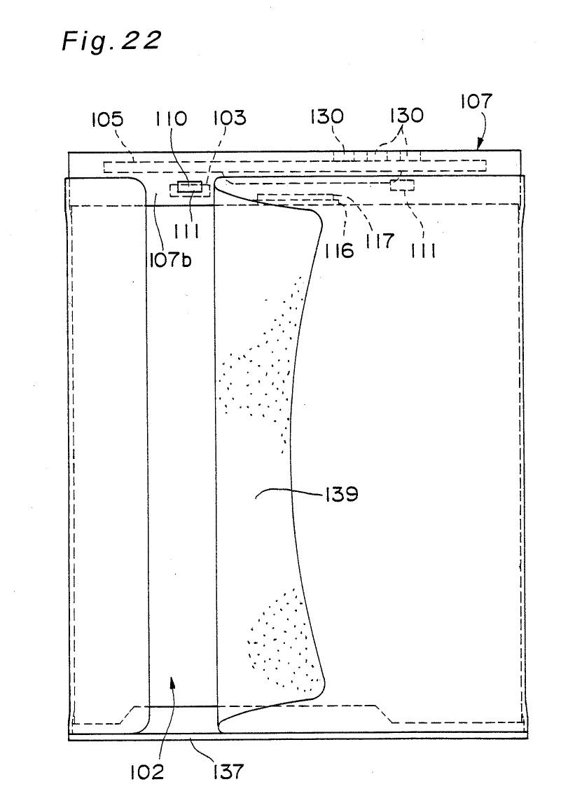

Onto a bottom surface of the unit cell 102, a bottom cover 137 shown in FIG. 17 and made of synthetic resin is stuck and fixed by a double-sided adhesive tape 138. As shown in FIG. 22, a label 139 composed of an insulative sheet or the like is stuck on an outer wall surface of the unit cell 102 and on lower part of the peripheral side wall 107b of the exterior cover 107. The bottom cover 137 may be fixed to the bottom surface of the unit cell 102 by laser welding. Provided that such laser welding is employed, the double-sided adhesive tape 138 is omitted. The exterior cover 107 may be fastened onto the holder 106 by laser welding, ultrasonic welding or the like. In such a case, the pawls 110 of the holder 106 and the engagement holes 111 of the exterior cover 107 are omitted.

Hereinbelow will be described a procedure for assembling the battery pack 101 of the sixth embodiment having such a configuration. Initially, the clad plate 127 is connected to the sealing plate 113 of the unit cell 102 by spot welding or the like, and the positive lead 126 is connected to the clad plate 127 by spot welding or the like. In this stage, as shown in FIGS. 18 and 19, the positive lead 126 is not bent but extends straight from the clad plate 127 toward lateral outside of the unit cell 2.

Subsequently, the holder 106 is placed on the top face of the unit cell 102 with the holder 106 put over the positive lead 126 and the clad plate 127 and with the negative terminal 117 and the insulative packing 116 of the unit cell 102 inserted into the insertion hole 131 of the bottom wall 106a of the holder 106 (a state in FIG. 18 and FIG. 19). In this state, the YAG laser beam 133 is applied from above to the thin wall part 132 of the bottom wall 106a of the holder 106, and the lower face of the thin wall part 132 is molten, so that the thin wall part 132 of the bottom wall 106a of the holder 106 is fixed to the top face of the unit cell 102 by laser welding.

On the other hand, the lower sides of the positive and negative connectors 124, 125 bent into shape of the letter U are connected by soldering or the like to the negative terminal 105b and the positive terminal 105c of the circuit board 105, respectively. The one connection terminal 103a of the protection element 103 is connected to the lead plate 122 by spot welding or the like, and the other connection terminal 103b of the protection element 103 is connected to the negative lead 123 by spot welding or the like. In this stage, the negative lead 123 is not bent but extends straight toward lateral outside of the protection element 103. In this state, the protection element 103 is placed on the bottom wall 106a of the holder 106, and the lead plate 122 is connected to the top surface of the negative terminal 117 of the unit cell 102 by spot welding or the like.

Subsequently, the circuit board 105 is held by the upper ends of the side walls 106b, 106b of the holder 106, and the positive and negative leads 123, 126 are bent upward and are connected to the positive and negative connectors 124, 125, respectively, by spot welding or the like. In the next step, the pawls 110 of the holder 106 are respectively engaged with the engagement holes 111 of the exterior cover 107, with the exterior cover 107 put over the circuit board 105 and the holder 106. Thus the exterior cover 107 is fastened to the holder 106 so as not to be easily released. After that, the bottom cover 137 is stuck and fixed onto the bottom surface of the unit cell 102 by the double-sided adhesive tape 138. Thus the battery pack 101 is finished. The label 139 is stuck on the finished battery pack 101, so that the outer peripheral surface of the unit cell 102 and the lower part of the peripheral side wall 107b of the exterior cover 107 are covered with the label 139.

In this manner, the holder 106 is fixed to the top face of the unit cell 102 by laser welding, therefore the holder 106 is reliably fixed to the unit cell 102 and is reliably prevented from coming off the unit cell 102 as a result of small impact or the like. The pawls 110 may be formed in and protruded from front and rear positions on the peripheral side wall 107b of the exterior cover 107, and the engagement holes 111 may be formed on the outer surfaces of the side walls 106b of the holder 106. The exterior cover 7 may be fastened onto the holder 106 by laser welding, ultrasonic welding or the like.

In the sixth embodiment, the holder 106 is fixed onto the unit cell 102 by laser welding. Therefore, the holder 106 can reliably be fixed to the unit cell 102 and the circuit board 105 can be prevented from easily coming off the unit cell 102, together with the holder 106. This leads to reliable prevention of falling of the holder 106 from the unit cell 102 and prevention of resultant falling of the leads connecting the circuit board 105 and the unit cell 102 from the circuit board 105, for instance.

Besides, screws or the like for fixing the holder 106 to the unit cell 102 are made unnecessary and thus increase in number of components can be avoided. This results in simplification of the fixation structure for the holder 106 and of labor of assembly thereof and reduction in cost of manufacturing the battery pack 101.

In the fixation structure in which the bottom wall 106a of the holder 106 is fixed onto the top face of the unit cell 102 by laser welding, the laser beam 133 can be applied perpendicularly to the bottom wall 106a of the holder 106. Thus energy of the laser beam 133 can reliably be concentrated on the contact part between the bottom wall 106a of the holder 106 and the top face of the unit cell 102. As a result, occurrence of poor welding can be reduced and the holder 106 can reliably be fixed to the unit cell 102.

### Seventh Embodiment

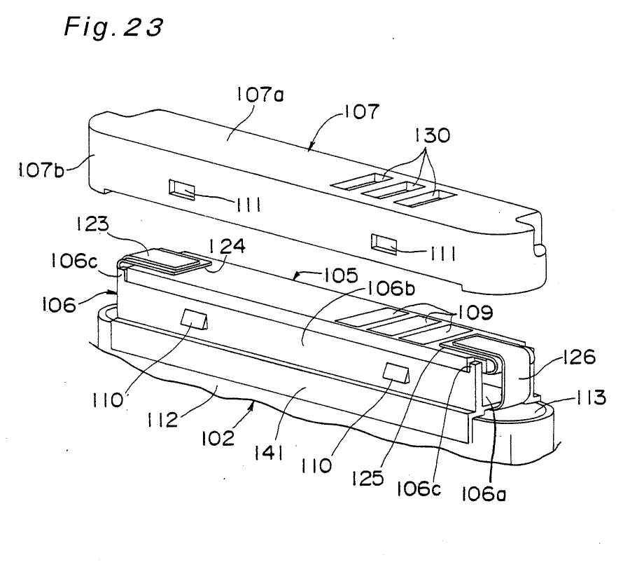

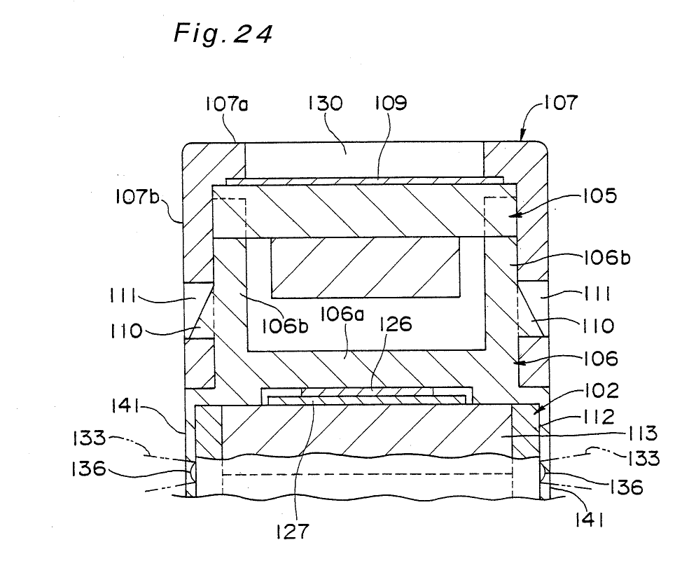

FIGS. 23 and 24 show a seventh embodiment of a battery pack according to the invention. The seventh embodiment is different from the sixth embodiment in that front and rear parts of a holder 106 are extended to lower positions than a top face of a unit cell 102 so as to form skirts 141, 141. In the seventh embodiment, an example of thin wall parts of the holder 106 is the skirts 141, and longitudinal thicknesses of the skirts 141 are defined on the order of 0.1 to 0.15 mm, for instance.

As shown in FIGS. 23 and 24, a YAG laser beam 133 is applied from a longitudinal direction, i.e., a horizontal direction to each skirt 141 of the holder 106 with a protection element 103 and a circuit board 105 held by the holder 106 and with the skirts 141 being in contact with an outer peripheral surface of a battery case 112 of the unit cell 102 (a state in FIG. 24). Thus a portion 136 irradiated with the YAG laser beam 133 is molten in a contact part between the skirt 141 and the outer peripheral surface of the battery case 112 of the unit cell 102, and the skirt 141 is thereby welded onto the outer peripheral surface of the battery case 112. That is, the skirt 141 of the holder 106 is fixed to the outer peripheral surface of the unit cell 102 by laser welding. Other points are the same as those of the sixth embodiment and description thereof is therefore omitted.

In the seventh embodiment, laser welding can the more easily be performed without being obstructed by the side walls 106b, 106b of the holder 106 and the like in laser welding because the YAG laser beam 133 can be applied from the longitudinal direction, i.e., the horizontal direction. The skirts 141 may be formed on whole periphery of the holder 106.

### Eighth Embodiment

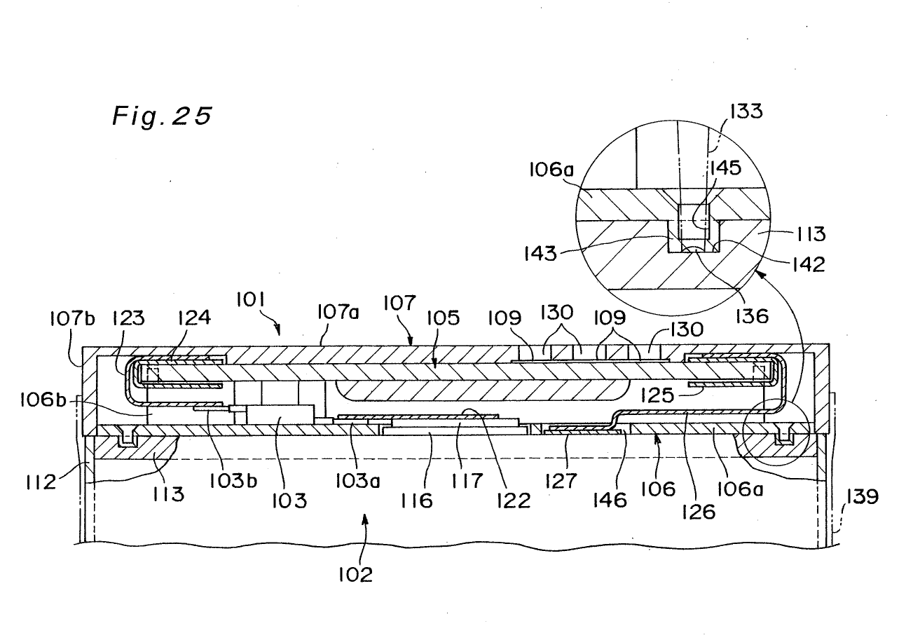

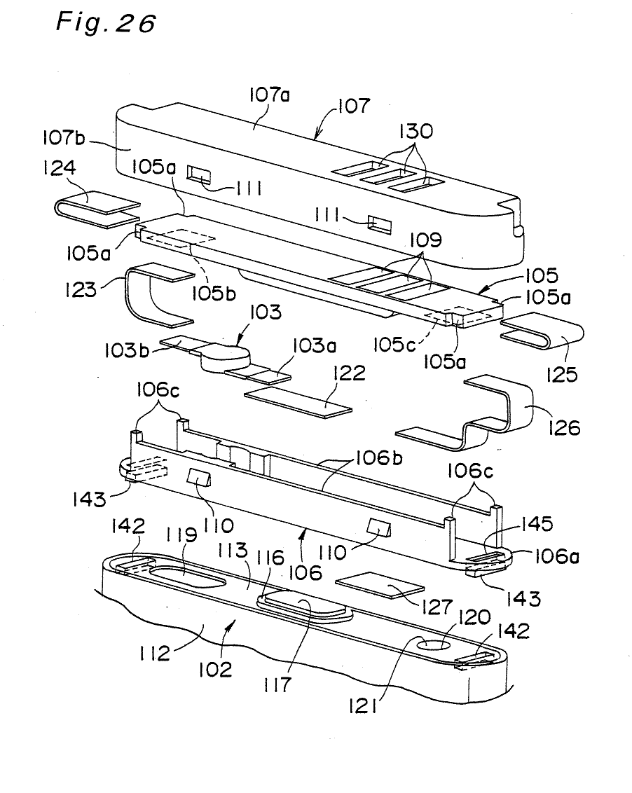

FIGS. 25 through 30 show an eighth embodiment of a battery pack according to the invention. As shown in FIGS. 25 and 26, the eighth embodiment is different from the sixth embodiment in that engagement recesses 142, 142 are formed so as to be recessed on left and right sides of a top face of a sealing plate 113 of a unit cell 102 and in that welding protrusions 143, 143 for engaging with the engagement recesses 142, 142 are formed on a lower surface of a bottom wall 106a of a holder 106 so as to protrude downward.

Both ends of the bottom wall 106a of the holder 106 are extended to outside of side walls 106b, 106b thereof in left and right lateral directions, and the welding protrusions 143, 143 are formed on lower surfaces of the left and right extended parts, respectively. As shown in FIGS. 26 and 28, each welding protrusion 143 has a shape elongated in a longitudinal direction and, correspondingly, each engagement recess 142 on the sealing plate 113 of the unit cell 102 also has a shape elongated in the longitudinal direction. As shown in FIG. 25, on an upper surface of the bottom wall 106a of the holder 106 are formed a plurality of upper surface recesses 145 extending from positions above the welding protrusions 143 to insides of the welding protrusions 143. In this manner, the upper surface recesses 145 are formed in positions corresponding to the welding protrusions 143, on the upper surface of the bottom wall 106a of the holder 106, so that vertical thicknesses of the welding protrusions 143 between bottom faces of the upper surface recesses 145 and lowest faces of the welding protrusions 143 can be made smaller than thicknesses of the other parts of the holder 106, that is, the welding protrusions 143 can be formed as thin wall parts. The vertical thicknesses between the bottom faces of the upper surface recesses 145 and the lowest faces of the welding protrusions 143 are set on the order of 0.1 to 0.15 mm, for instance.

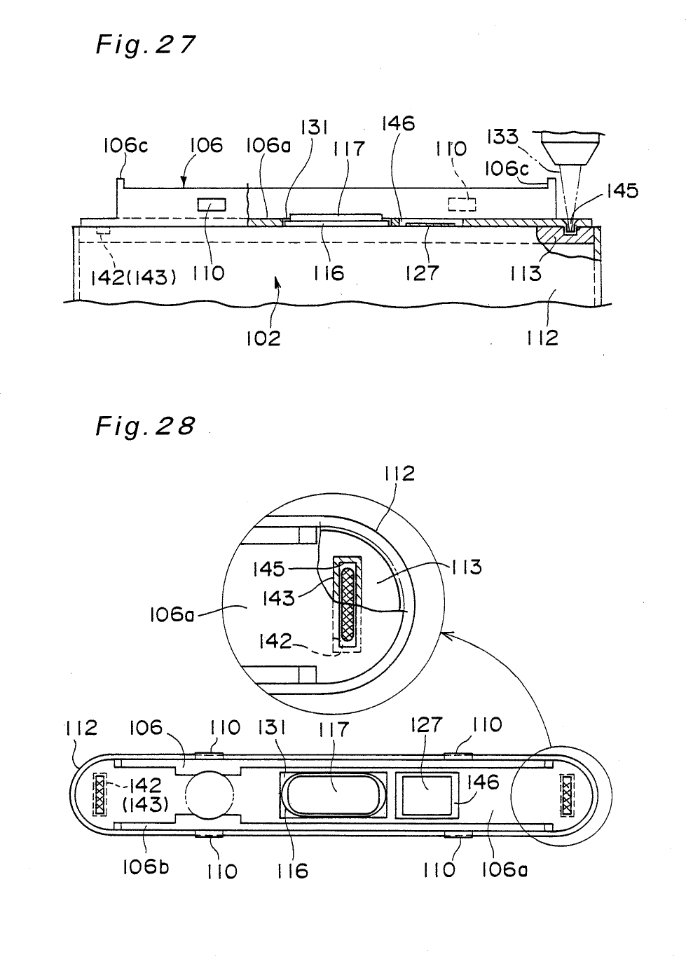

On the bottom wall 106a of the holder 106, as shown in FIGS. 27 and 28, a through hole 146 for exposing a clad plate 127 is formed on a side of a positive lead 126 (right side in FIG. 28) with respect to an insertion hole 131 on lateral center part thereof.

In the holder 106, lower ends of the welding protrusions 143 are fixed to bottom surfaces of the engagement recesses 142 of the sealing plate 113 of the unit cell 102 by laser welding. That is, as shown in FIG. 27, a YAG laser beam 133 is applied from above perpendicularly in general into each upper surface recess 145 of the bottom wall 106a of the holder 106. As shown in FIG. 25, a portion 136 irradiated with the YAG laser beam 133 is thereby molten in a contact part between each welding protrusion 143 of the bottom wall 106a and each engagement recess 142 of the sealing plate 113 of the unit cell 102, and the holder 106 is welded onto the bottom surface of each engagement recess 142 of the unit cell 102.

Hereinbelow will be described a procedure for assembling the battery pack 101 of the eighth embodiment having such a configuration. In a manner similar to the sixth embodiment, the clad plate 127 is connected to the sealing plate 113 of the unit cell 102 by spot welding or the like, and lower sides of positive and negative connectors 124, 125 in shape of a letter U are connected by soldering or the like to a negative terminal 105b and an positive terminal 105c of a circuit board 105, respectively. One connection terminal 103a of a protection element 103 is connected a lead plate 122 by spot welding or the like, and the other connection terminal 103b of the protection element 103 is connected by spot welding or the like to a negative lead 123 extending straight.

With the negative terminal 117 and an insulative packing 116 of the unit cell 102 inserted into the insertion hole 131 of the bottom wall 106a of the holder 106 and with the clad plate 127 positioned in the through hole 146, subsequently, the welding protrusions 143 of the holder 106 are engaged with the engagement recesses 142 of the sealing plate 113 of the unit cell 102, and the holder 106 is placed on the top face of the unit cell 102 (a state in FIG. 27 and FIG. 28). In this state, the YAG laser beam 133 is applied from above into the upper surface recesses 145 of the bottom wall 106a of the holder 106, and the welding protrusions 143 of the holder 106 are fixed to the engagement recesses 142 of the sealing plate 113 of the unit cell 102 by laser welding.

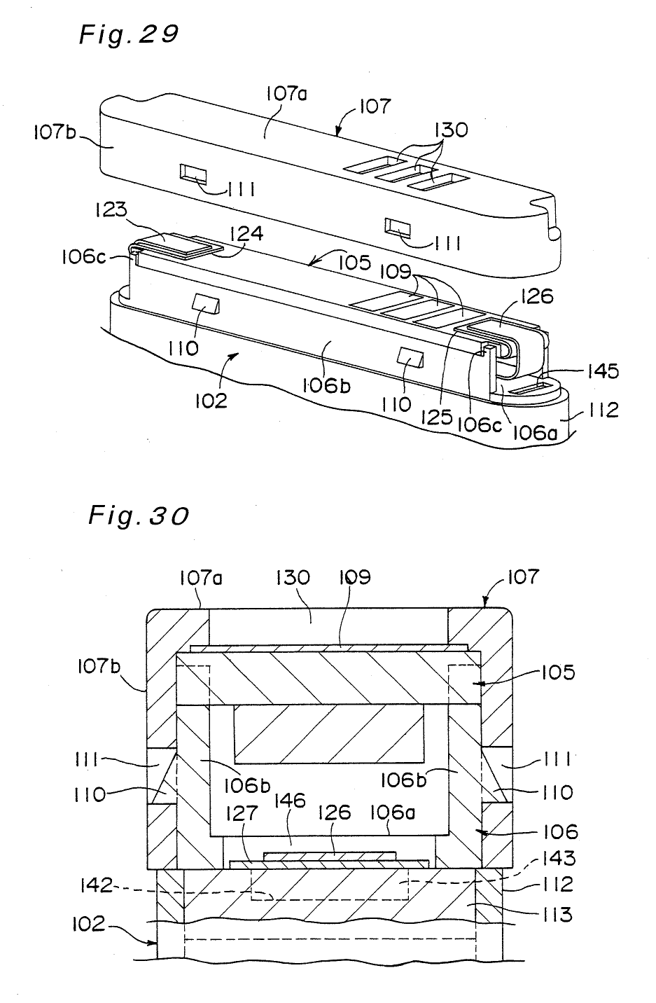

Subsequently, the positive lead 126 extending straight is connected by spot welding or the like to the clad plate 127 positioned in the through hole 146 of the bottom wall 106a of the holder 106. Then the protection element 103 is placed on the bottom wall 106a of the holder 106, and the lead plate 122 is connected to a top surface of the negative terminal 117 of the unit cell 102 by spot welding or the like. In the next step, the circuit board 105 is held by upper ends of the side walls 106b, 106b of the holder 106, and the positive and negative leads 123, 126 are bent upward and are connected to the positive and negative connectors 124, 125, respectively, by spot welding or the like (a state in FIG. 29).

After that, the exterior cover 107 is put over the circuit board 105 and the holder 106, and pawls 110 of the holder 106 are respectively engaged with engagement holes 111 of the exterior cover 107, so that the exterior cover 107 is fastened to the holder 106 so as not to be easily released (a state in FIG. 30). Subsequently, a bottom cover 137 is fixed onto a bottom surface of the unit cell 102 by a double-sided adhesive tape 138, and a label 139 is stuck on the battery pack 101. Other points are the same as those of the sixth embodiment and description thereof is therefore omitted.

In the eighth embodiment, strength of the holder 106 in transverse directions can be increased all the more because the engagement between the welding protrusions 143 of the holder 106 and the engagement recesses 142 of the unit cell 102 prevents the holder 106 from moving in the transverse directions by influence of impact or the like. Besides, the welding protrusions 143 can be fixed to the engagement recesses 142 by the perpendicular application of the laser beam 133 to the bottom wall 106a of the holder 106, and thus energy of the laser beam 133 can reliably be concentrated on the contact part between the welding protrusion 143 and the engagement recess 142, so that reduction of occurrence of poor welding and reliable fixation of the holder 106 to the unit cell 102 can be attained.

### Ninth Embodiment

FIG. 31 shows a ninth embodiment of a battery pack according to the invention. In the ninth embodiment, engagement protrusions 148, 148 are formed so as to protrude upward on both left and right end parts of a top face of a sealing plate 113 of a unit cell 102. Correspondingly, welding recesses 149, 149 for engaging with the engagement protrusions 148, 148 are formed on a lower surface of a bottom wall 106a of a holder 106 so as to be recessed upward. That is, the welding recesses 149, 149 are formed on lower surfaces of both end parts of the bottom wall 106a of the holder 106 which parts are extended laterally to outside of side walls 106b, 106b thereof. A vertical thickness between upmost surfaces of the welding recesses 149 and upper surface side of the bottom wall 106a of the holder 106 is set on the order of 0.1 to 0.15 mm, for instance.

In a state in which the welding recesses 149 are respectively engaged with the engagement protrusions 148 and in which the holder 106 is placed on the top face of the unit cell 102 (a state in FIG. 31), the welding recesses 149 are respectively fixed to the engagement protrusions 148 by laser welding with use of YAG laser beam 133. Other points are the same as those of the eighth embodiment and description thereof is therefore omitted.

In the ninth embodiment also, strength of the holder 106 in transverse directions can be increased all the more because the engagement between the welding recesses 149 of the holder 106 and the engagement protrusions 148 of the unit cell 102 prevents the holder 106 from moving in the transverse directions by influence of impact or the like.

Namely, welding fixation by laser welding is preferably performed with engagement between engaging parts in shape of recesses or protrusions that can be formed, as engaging parts for welding, on the holder 106 and engaging parts that are formed on the unit cell 102 so as to be engaged with the shapes of the recesses or protrusions.

The battery packs 101 of the sixth through ninth embodiments employ configurations in which the protection element 103 is held by the holder 106. Thus the protection element 103 can be held by the holder 106 and prevented from shaking in an exterior cover 107. Accordingly, the protection element 103 can be prevented from being rubbed and damaged by an inner surface of the exterior cover 107 or the like. Besides, there is an advantage in that the holder 106 can effectively be utilized.

### Tenth Embodiment

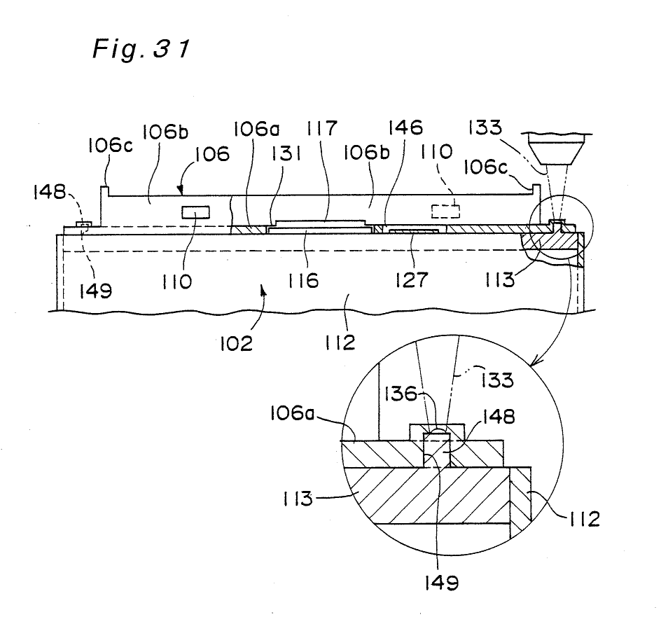

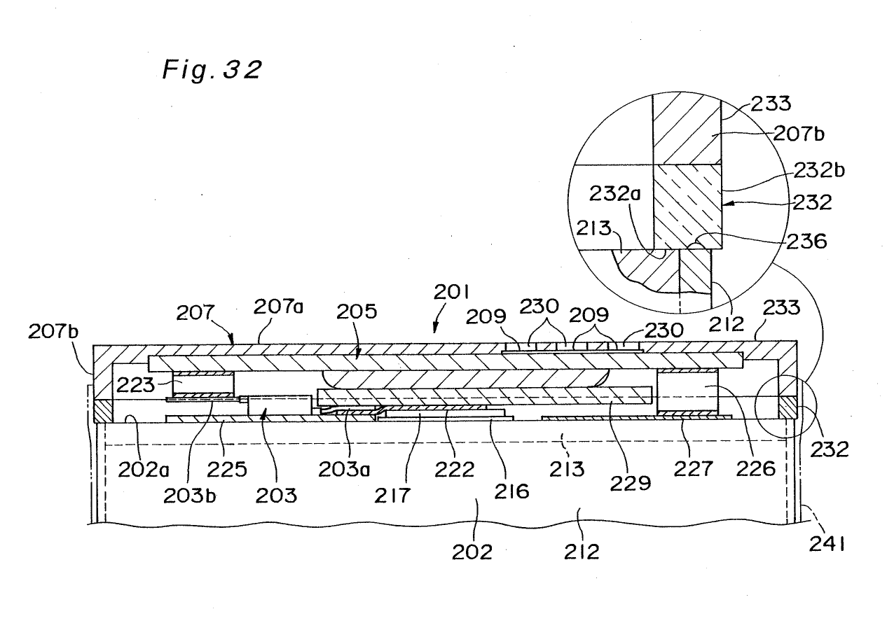

FIGS. 32 through 36 show a tenth embodiment of a battery pack according to the invention. As shown in FIGS. 32 through 34, a battery pack 201 has a unit cell 202 including a battery case 212 having an upper face opening and made of metal and including a sealing plate 213 closing the upper face opening of the battery case 212 and made of metal, a protection element 203 placed above the sealing plate 213, a circuit board 205 placed above the sealing plate 213, and an exterior cover 207 covering the protection element 203 and the circuit board 205 and made of resin (e.g., synthetic resin). The protection element 203 is composed of a thermal fuse (PTC) or the like. Battery packs of the tenth through fourteenth embodiments present examples in which a holder for holding a circuit board is an exterior cover.

Specifically, the unit cell 202 is a secondary cell such as lithium ion battery that allows discharge and charge thereof. Three external connection terminals 209 are formed in a row along a lateral direction on a top surface of the circuit board 205, and electronic components that form a protection circuit (safety circuit) and the like are placed on a bottom surface of the circuit board 205. The electronic components that form the protection circuit are covered with resin.

In the unit cell 202, the sealing plate 213 is seam-welded by laser on periphery of the opening of the battery case 212. The battery case 212 is formed by deep drawing of a metal plate made of aluminum or alloy thereof. The sealing plate 213 is formed by press working of a plate made of metal such as aluminum alloy. In the unit cell 202 are enclosed an electrode unit and electrolyte (not shown). In the electrode unit, an positive-electrode sheet having LiCoO₂ as positive active material and a negative-electrode sheet having graphite as negative-electrode active material are coiled like a volute with a separator made of synthetic resin between, and the whole unit is flatly shaped.

At lateral center of the sealing plate 213 of the unit cell 202, a negative terminal 217 is mounted through medium of an insulative packing 216 so as to pierce the sealing plate 213. The negative terminal 217 is electrically connected with the negative-electrode of the electrode unit in the unit cell 202. Electrical continuity exists also between the battery case 212, the sealing plate 213 and the positive-electrode of the electrode unit in the unit cell 202. On one end side of lateral sides of the sealing plate 213 is formed a cleavage vent 219, which has a function of releasing an internal pressure of the battery by being cloven in case that the internal pressure abnormally increases. On the other end side of the lateral sides of the sealing plate 213 is formed a liquid injection hole 220 through which nonaqueous electrolyte is to be injected into the unit cell 202. After the electrolyte is injected, the liquid injection hole 220 is closed by a sealing plug 221 and is sealed by laser.

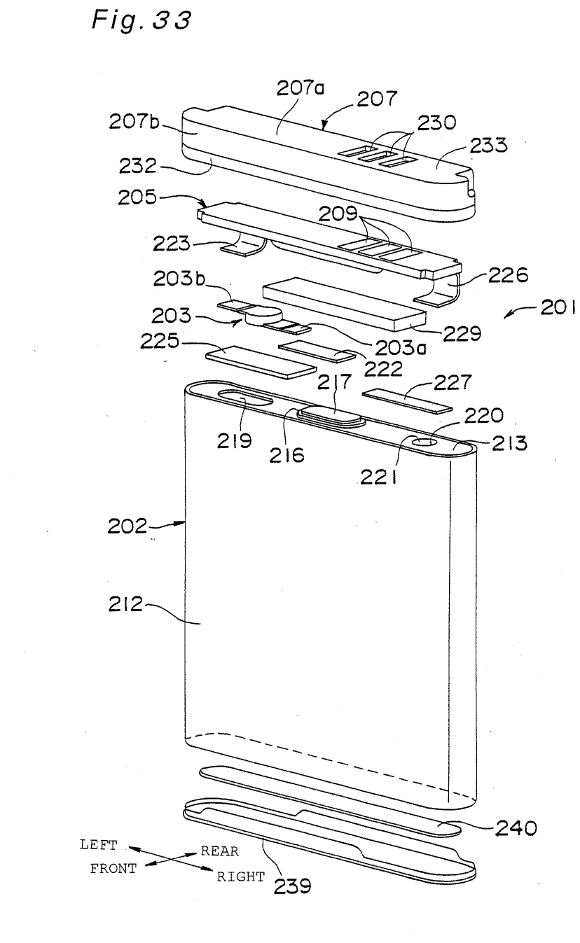

As shown in FIGS. 32 and 33, one connection terminal 203a of the protection element 203 is connected through a thin lead plate 202 to a top surface of the negative terminal 217 of the unit cell 202, and the other connection terminal 203b of the protection element 203 is connected to a negative lead 223 shaped like a thin plate that is provided on one end side of lateral sides on the bottom surface of the circuit board 205. Each of the connection terminals 203a and 203b of the protection element 203 is formed of a nickel plate or the like. Between the protection element 203 and the sealing plate 213 of the unit cell 202 is placed an insulating plate 225 made of synthetic resin, which insulates the protection element 203 from the sealing plate 213 and holds the element.

A positive lead 226 shaped like a thin plate that is provided on the other end side of the lateral sides on the bottom surface of the circuit board 205 is connected to the sealing plate 213 of the unit cell 202 through a clad plate 227 formed of aluminum and nickel. Each of the positive and negative leads 223 and 226 of the circuit board 205 is formed of a nickel plate or the like. The positive lead 226 may directly be connected to the sealing plate 213 of the unit cell 202. Between the circuit board 205 and the sealing plate 213 of the unit cell 202 is placed a holder 229 made of synthetic resin, through which the circuit board 205 is held above the sealing plate 213 of the unit cell 202.

The exterior cover 207 includes a laterally oblong top wall 207a and a peripheral side wall 207b extending downward from an outer periphery of the top wall 207a and having at least part of a lower end portion in close contact with a top face 202a of the unit cell 202. The exterior cover 207 is formed by injection molding from resin material such as polycarbonate (PC), polyamide (PA), polyethylene terephthalate (PET) or polypropylene (PP), that is, from synthetic resin material. In the exterior cover 207 are formed, by coinjection molding, a laser permeable part 232 that allows permeation therethrough of visible light and a YAG laser beam 231 for welding and an impermeable part 233 that allows neither permeation therethrough of visible light nor permeation therethrough of the YAG laser beam 231. Such formation of the exterior cover 207 by coinjection molding makes it easier to manufacture the exterior cover 7 than separate formation and affixation of the laser permeable part 232 and the impermeable part 233.

As shown in FIGS. 32 and 35, the laser permeable part 232 is formed in the lower end portion (opening end portion) of the peripheral side wall 207b of the exterior cover 207 so as to form a portion of an outer surface of the lower end portion and so as to have a lower end face 232a in close contact with the top face 202a of the unit cell 202. The laser permeable part 232 is placed in a position corresponding to a region for welding to the unit cell 202 and, specifically, is formed along and round the lower end of the peripheral side wall 207b of the exterior cover 207 (see FIG. 33). A peripheral edge portion of the top face 202a that is an outer wall surface of the unit cell 202 and the lower end face 232a of the laser permeable part 232 that is in close contact with the peripheral edge portion (outer wall surface) are welded by laser welding with use of the YAG laser beam 231, so that the exterior cover 207 is welded and fixed onto the unit cell 202. In the exterior cover 207, for instance, the impermeable part 233 corresponds to all parts except the laser permeable part 232.

Though the tenth embodiment is described with reference to an example in which the laser permeable part 232 is formed of resin material that allows permeation therethrough of visible light and the YAG laser beam 231, it is not necessary for the laser permeable part 232 to allow permeation therethrough of visible light (i.e., to be transparent). The laser permeable part 232 may be formed of resin material that allows at least permeation therethrough of the YAG laser beam 231 and may be formed of semitransparent resin material, besides colorless transparent resin material. On condition that welding is performed with use of the YAG laser beam 231, for instance, resin material that allows permeation therethrough of a wavelength of 1064 nm (infrared ray) of the YAG laser beam 231 is used for the laser permeable part 232. Though the laser permeable part 232 preferably allows permeation therethrough of all components of the laser beam 231, the laser permeable part 232 has only to allow permeation therethrough of greater part of the laser beam 231.

Though the example has been described in which parts of the exterior cover 207 other than the laser permeable part 232 are formed as the impermeable part 233, the whole exterior cover 207 may be formed as the laser permeable part 232. The impermeable part 233 is formed of resin material that has a transmittance of the laser beam 231 relatively lower than the laser permeable part 232 has and may be formed of transparent or semitransparent resin material that allows permeation therethrough of visible light. In consideration of appearance of the exterior cover 207, the impermeable part 233 is preferably colored with black or the like that resists permeation of visible light. In molding of the exterior cover 207, for instance, the impermeable part 233 is molded in a first process of the molding and the laser permeable part 232 is molded in a second process of the molding.

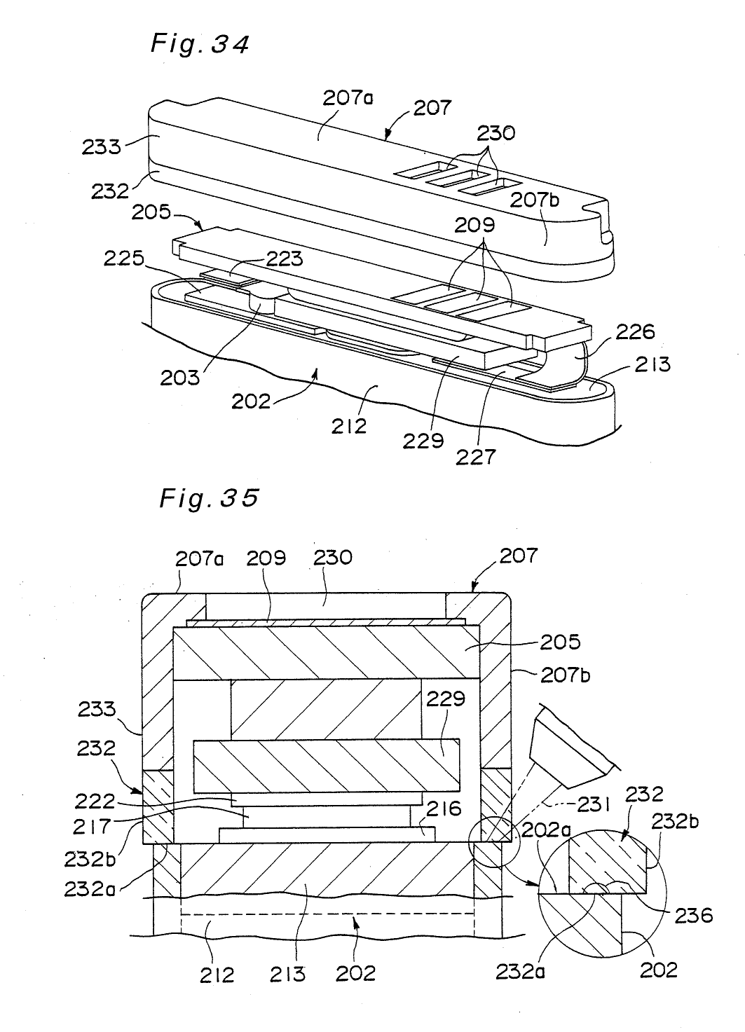

On the top wall 207a of the exterior cover 207, as shown in FIGS. 32 and 34, three windows 230 are formed at locations corresponding to the external connection terminals 209 of the circuit board 205. Thus the external connection terminals 209 of the circuit board 205 are exposed on an outer surface of the battery pack 201 through the windows 230 of the exterior cover 207, so that contact of connection terminals (not shown) of external equipment with the external connection terminals 209 allows input and output of charge and discharge currents into and from the unit cell 202. Thicknesses of the exterior cover 207 are defined between 0.4 and 0.5 mm, for instance.

As shown in FIG. 35, the YAG laser beam 231 is applied from a diagonally above direction toward an outer surface 232b of the laser permeable part 232. Thus the YAG laser beam 231 permeates through the laser permeable part 232 and reaches a welding part (welding surface) 236 that is a part including the lower end face 232a of the laser permeable part 232 and that is in close contact with the peripheral edge portion of the top face 202a of the unit cell 202, so that the welding part 236 is molten, welded and fixed onto the peripheral edge portion of the top face 202a of the unit cell 202. That is, only the welding part 236 is molten by the YAG laser beam 231 in the laser permeable part 232 of the exterior cover 207, and a portion of the molten resin enters minute depressions and projections of metal on the top face 202a of the unit cell 202 and is then solidified, so that the lower end face 232a of the laser permeable part 232 of the exterior cover 207 is fixed to the peripheral edge portion of the top face 202a of the unit cell 202 by anchor effect and the like.

The whole lower end face 232a of the laser permeable part 232 of the exterior cover 207 may be welded onto the peripheral edge portion of the top face 202a of the unit cell 202 by the YAG laser beam 231 or the lower end face 232a of the laser permeable part 232 of the exterior cover 207 may be welded at specified intervals along the peripheral edge portion of the top face 202a of the unit cell 202 by the YAG laser beam 231. A wavelength of the YAG laser beam 231 used for such laser welding is set at 1064 nm and an output thereof is set between 30 and 700 W, for instance.

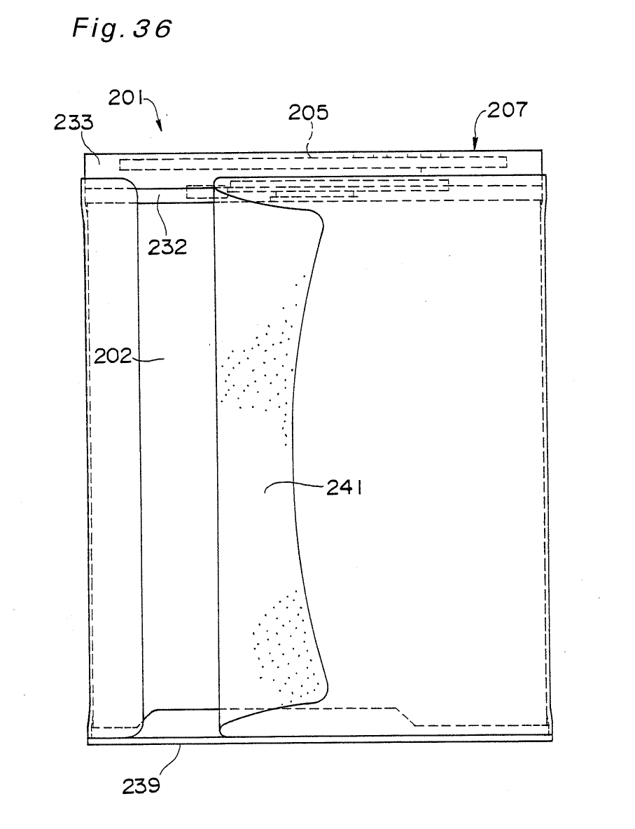

Onto a bottom surface of the unit cell 202, a bottom cover 239 shown in FIG. 33 and made of synthetic resin is stuck and fixed by a double-sided adhesive tape 240. As shown in FIG. 36, a label 241 composed of an insulative sheet or the like is stuck on an outer wall surface of the unit cell 202 and on lower part of the peripheral side wall 207b of the exterior cover 207. The bottom cover 239 may be fixed to the bottom surface of the unit cell 202 by laser welding. In this case, the double-sided adhesive tape 240 is omitted.

Hereinbelow will be described a procedure for assembling the battery pack 201 having such a configuration. Initially, the one connection terminal 203a of the protection element 203 is connected to one end side of the lead plate 222 by spot welding or the like, and the other end side of the lead plate 222 is connected to the top surface of the negative terminal 217 of the unit cell 202 by spot welding or the like. On this occasion, the insulating plate 225 is placed on top of the sealing plate 213 of the unit cell 202, and the protection element 203 is placed on top of the insulating plate 225. Before being assembled, the leads 223 and 226 of the circuit board 205 are not bent but extend straight in one of the longitudinal directions from lateral end parts of the circuit board 205.

The clad plate 227 is connected to the sealing plate 213 of the unit cell 202 by spot welding or the like, and an extremity of the positive lead 226 of the circuit board 205 is connected to the clad plate 227 by spot welding or the like. Subsequently, an extremity of the negative lead 223 of the circuit board 205 is connected to the other connection terminal 203b of the protection element 203 by spot welding or the like. After the holder 229 is placed in a specified position on top of the sealing plate 213 of the unit cell 202, both the leads 223 and 226 of the circuit board 205 are bent and the circuit board 205 is placed on the holder 229 (a state of FIG. 34).

After that, the exterior cover 207 is put over the protection element 203 and the circuit board 205, in a posture in which the windows 233 of the exterior cover 207 are placed so as to correspond to the external connection terminals 209 of the circuit board 205, and the lower end face 232a of the laser permeable part 232 of the exterior cover 207 is brought into close contact with the peripheral edge portion of the top face 202a of the unit cell 202 (a state in FIG. 35). In this state, the YAG laser beam 231 is applied from the diagonally above direction toward the outer surface 232b of the laser permeable part 232, so that the lower end face 232a of the laser permeable part 232 of the exterior cover 207 is welded and fixed to the peripheral edge portion of the top face 202a of the unit cell 202 by the YAG laser beam 231 permeated through the laser permeable part 232. Thus the battery pack 201 is finished. The label 241 is stuck on the finished battery pack 201, so that the outer wall surface of the unit cell 202 and the lower part of the peripheral side wall 207b of the exterior cover 207 are covered with the label 241. Onto the bottom surface of the unit cell 202 is fixed the bottom cover 239.

In this manner, the exterior cover 207 is reliably fixed to the unit cell 202 because the lower end face 232a of the laser permeable part 232 of the exterior cover 207 is fixed by laser welding to the peripheral edge portion of the top face 202a of the unit cell 202. Accordingly, the exterior cover 207 is reliably prevented from coming off the unit cell 202 as a result of small impact or the like. The laser permeable part 232, which is made of material that allows permeation therethrough of the YAG laser beam 231, reduces attenuation of energy and permits the YAG laser beam 231 to efficiently reach the welding part 236. That is, the welding part 236 can reliably be molten by small laser output and thus thermal effect on surroundings (e.g., the unit cell) of the welding part 236 can be reduced.

### Eleventh Embodiment

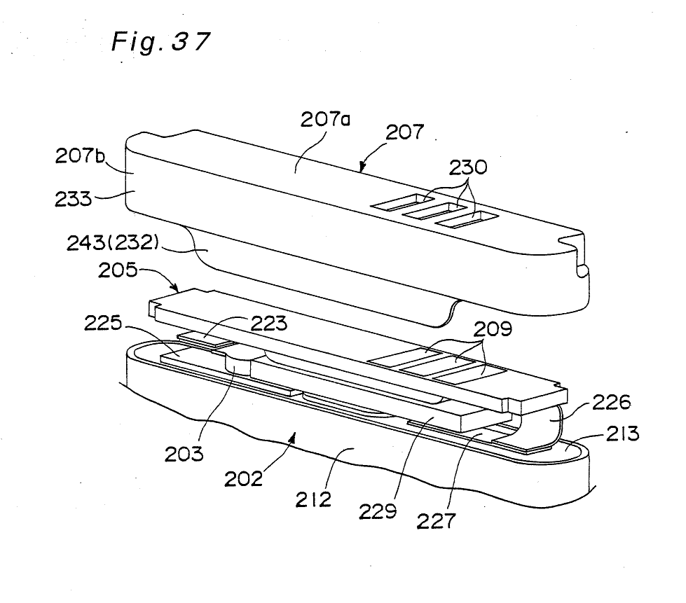

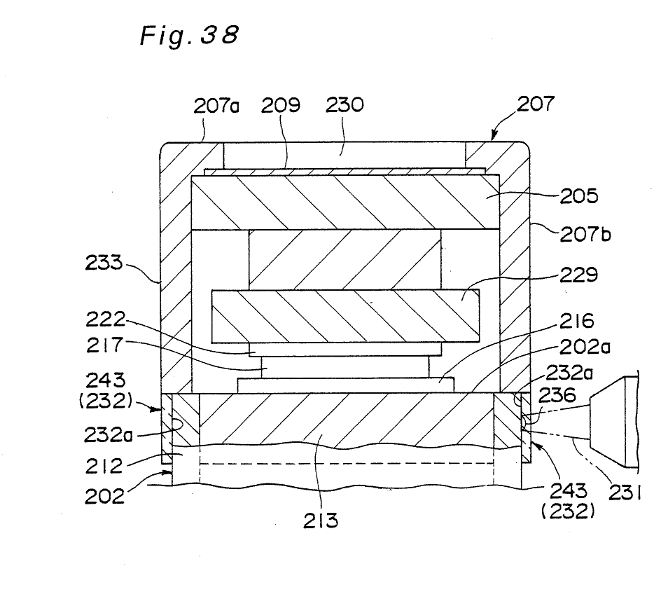

FIGS. 37 and 38 show an eleventh embodiment of a battery pack according to the invention. In the eleventh embodiment, as shown in FIGS. 37 and 38, front and rear parts of a lower end portion of a peripheral side wall 207b of an exterior cover 207 are extended to lower positions than a top face 202a of a unit cell 202 so as to form skirts 243, 243, respectively, each of which is formed as a laser permeable part 232. That is, the skirts 243 of the exterior cover 207 allow permeation therethrough of visible light and a YAG laser beam 231, and parts thereof other than the skirts 243, 243 form an impermeable part 233. The skirts 243 and the impermeable part 233 are formed by coinjection molding.

As shown in FIG. 38, the YAG laser beam 231 is applied from a front or rear direction (i.e., a horizontal direction) toward an outer surface of each skirt 243 of the exterior cover 207, with the exterior cover 207 put over a protection element 203 and a circuit board 205 and with inner wall surfaces (lower end faces) 232a of the skirts 243 (laser permeable parts 232) being in close contact with an outer wall surface of a battery case 212 of the unit cell 202. Thus the YAG laser beam 231 permeates through each skirt 243 and reaches a welding part 236 that is a part of the inner wall surface 232a of the skirt 243 and that is in close contact with the outer wall surface of the battery case 212 of the unit cell 202, and the welding part 236 is thereby molten, so that welding onto the outer wall surface of the battery case 212 of the unit cell 202 is achieved. That is, the inner wall surfaces 232a of the skirts 243 of the exterior cover 207 are welded and fixed to the outer wall surface of the unit cell 202 by laser welding. Other points are the same as those of the tenth embodiment and description thereof is therefore omitted.

In the eleventh embodiment, laser welding can the more easily be performed without being obstructed by the exterior cover 207 in laser welding because the YAG laser beam 231 can be applied from a longitudinal direction (i.e., horizontal direction). The laser permeable part 232 may be provided in only part of each skirt 243. In this case, the YAG laser beam 231 is applied from a front or rear direction toward an outer surface of the laser permeable part 232 of the skirt 243 of the exterior cover 207 in a state in which the inner wall surfaces 232a on the laser permeable parts 232 of the skirts 243 are in close contact with the outer wall surface of the battery case 212 of the unit cell 202. The skirts 243 may be formed along and round the lower end of the peripheral side wall 207b of the exterior cover 207.

### Twelfth Embodiment

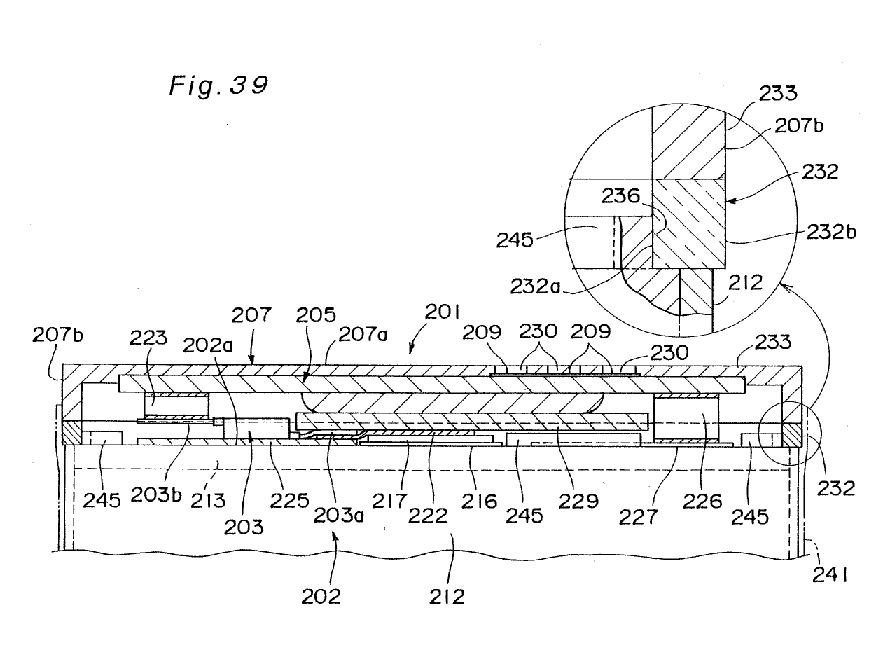

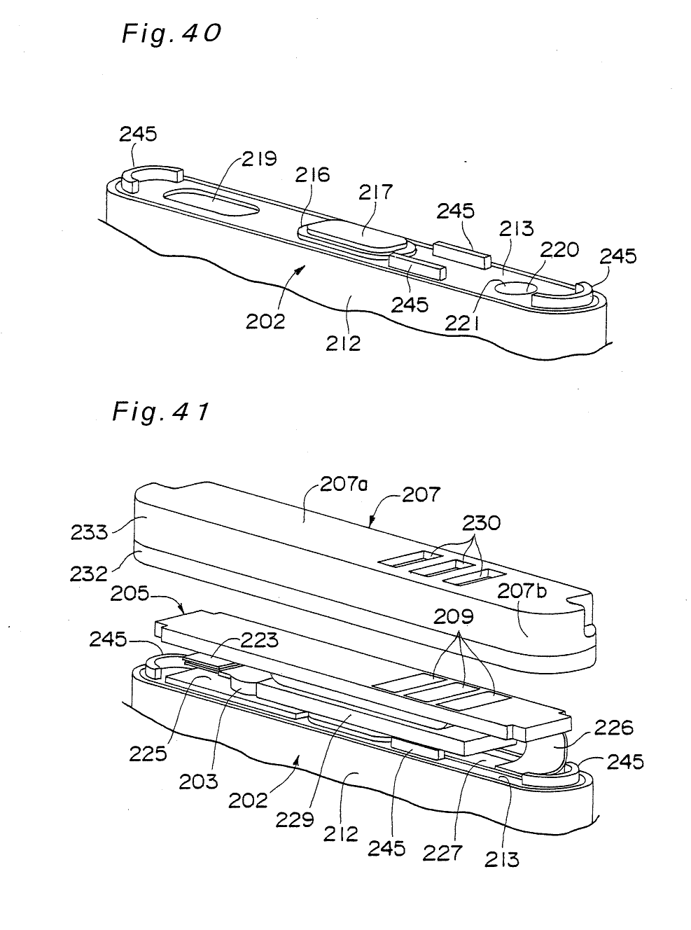

FIGS. 39 through 42 show a twelfth embodiment of a battery pack according to the invention. In the twelfth embodiment, as shown in FIG. 40, four welding protrusions 245 are formed so as to protrude upward on a top surface of a sealing plate 213 of a unit cell 202. The welding protrusions 245 are formed along periphery of the sealing plate 213. That is, on the top surface of the sealing plate 213 of the unit cell 202, two welding protrusions 245 are formed in shape of circular arcs along left and right circular peripheral parts of the sealing plate 213, and two welding protrusions 245 are formed in a linear shape along front and rear linear peripheral parts of the sealing plate 213.

As shown in FIGS. 39 and 41, the laser permeable part 232 is formed in a lower end portion of a peripheral side wall 207b of an exterior cover 207 so as to extend round along the lower end of the peripheral side wall 207b of the exterior cover 207, in a manner similar to that in the tenth embodiment. The laser permeable part 232 forms part of an outer surface of the lower end portion of the peripheral side wall 207b of the exterior cover 207 and has an inner wall surface 232a in close contact with outer wall surfaces of the welding protrusions 245 of the unit cell 202.

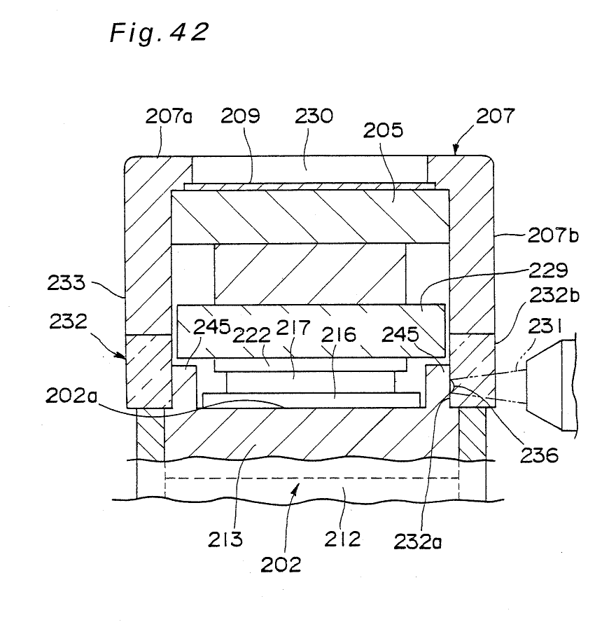

As shown in FIGS. 39 and 42, a YAG laser beam 231 is applied from a transverse direction (i.e., horizontal direction) toward an outer surface 232b of the laser permeable part 232 of the exterior cover 207, with the exterior cover 207 put over a protection element 203 and a circuit board 205 and with the inner wall surface 232a of the laser permeable part 232 of the exterior cover 207 being in close contact with the outer wall surfaces of the welding protrusions 245. Thus the YAG laser beam 231 permeates through the laser permeable part 232 and reaches a part (welding part) 236 that is irradiated with the YAG laser beam 231 in an close contact part between the inner wall surface 232a of the laser permeable part 232 of the exterior cover 207 and the outer wall surface of a welding protrusion 245 of the unit cell 202, so that the welding part 236 is molten and welded onto the welding protrusion 245 of the unit cell 202. That is, the inner wall surface 232a of the laser permeable part 232 of the exterior cover 207 is fixed by laser welding to the outer wall surfaces of the welding protrusions 245 of the unit cell 202. Other points are the same as those of the tenth embodiment and description thereof is therefore omitted.

In the twelfth embodiment, strength of the exterior cover 207 in the transverse directions can be increased all the more because the welding protrusions 245 prevent the exterior cover 207 from moving in the transverse directions by influence of impact or the like, in addition to reliable welding fixation attained by employment of laser welding.

### Thirteenth Embodiment

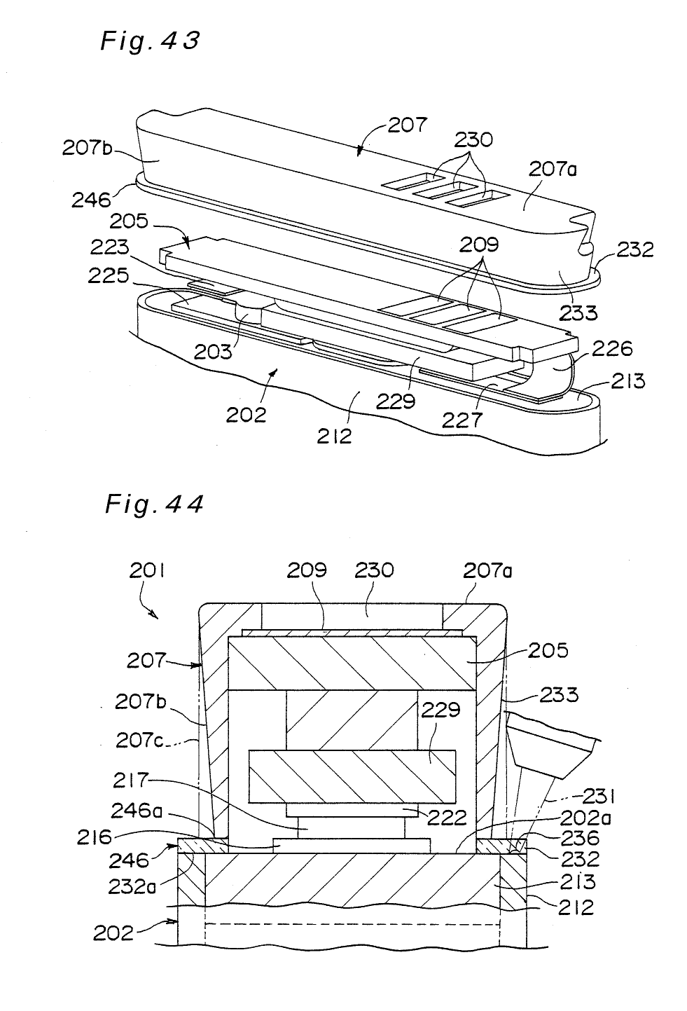

FIGS. 43 and 44 show a thirteenth embodiment of a battery pack according to the invention. In the thirteenth embodiment, as shown in FIGS. 43 and 44, a horizontal flange 246 is formed on outer periphery of a lower end of a peripheral side wall 207b of an exterior cover 207. The flange 246 allows permeation therethrough of visible light and a YAG laser beam 231. That is, the flange 246 is formed as a laser permeable part 232. In the flange 246, as shown in FIG. 44, a base end 246a of protrusion from the peripheral side wall 207b of the exterior cover 207 is positioned closer to inside of the exterior cover 207 than a reference surface 207c defined by an external shape of a top wall 207a of the exterior cover 207. Specifically, thicknesses of the peripheral side wall 207b are made the smaller at the lower position in the drawing, and thus an outer wall surface of the peripheral side wall 207b is made a slant surface that is positioned the closer to inside of the exterior cover 207 at the lower position.

The YAG laser beam 231 is applied from above toward an upper surface of the flange 246 of the exterior cover 207, with the exterior cover 207 put over a protection element 203 and a circuit board 205 and with an inner wall surface (lower surface) 232a of the flange 246 being in close contact with a peripheral edge portion of a top face 202a of a unit cell 202. Thus the YAG laser beam 231 permeates through the flange 204 and reaches a part (welding part) 236 that is irradiated with the YAG laser beam 231 in close contact part between the lower end surface 232a of the flange 246 of the exterior cover 207 and the peripheral edge portion of the top face 202a of the unit cell 202, so that the welding part 236 is molten and welded onto the peripheral edge portion of the top face 202a of the unit cell 202. Namely, the lower end face 232a of the flange 246 of the exterior cover 207 is welded and fixed by laser welding to the peripheral edge portion of the top face 202a of the unit cell 202. Other points are the same as those of the tenth embodiment and description thereof is therefore omitted.

In the thirteenth embodiment, the YAG laser beam 231 can be applied at an angle nearly perpendicular to the top surface of the flange 246 of the exterior cover 207. Thus energy of the laser beam 231 can reliably be concentrated on the close contact part between the bottom surface of the flange 246 and the peripheral edge portion of the top face 202a of the unit cell 202, so that reliable welding of the exterior cover 207 to the unit cell 202 can be attained. Besides, the protrusion base end 246a of the flange 246 that is positioned with deviation toward inside of the exterior cover 207 increases an area of the top surface of the flange 246, so that the YAG laser beam 231 can reliably be applied to the top surface of the flange 246.

The outer wall surface of the peripheral side wall 207b that is formed of the slant surface prevents interference between an emission unit of the YAG laser beam 231 and the peripheral side wall 207b and allows the YAG laser beam 231 to be applied from positions closer to the flange 246. It is also advantageous that the formation of the slant surface on the outer wall surface side of the peripheral side wall 207b avoids decrease in inner volume of the exterior cover 207 which might be caused by the provision of the slant surface and thus avoids impairment in a space for accommodating items to be accommodated such as the protection element 203.

The flange 246 may be formed on whole circumference of the peripheral side wall 207b of the exterior cover 207, as shown in FIG. 43, or may be formed only on some parts of the circumference of the peripheral side wall 207b of the exterior cover 207. The outer wall surface of the peripheral side wall 207b of the exterior cover 207 may be slanted as a whole, as shown in FIG. 43, or only lower part thereof may be slanted. The laser permeable part 232 may be provided in only part of the flange 246 by allowance of permeation therethrough of visible light and the YAG laser beam 231 in only the part of the flange 246. In this case, the YAG laser beam 231 is applied only to the laser permeable part 232 of the flange 246.

### Fourteenth Embodiment

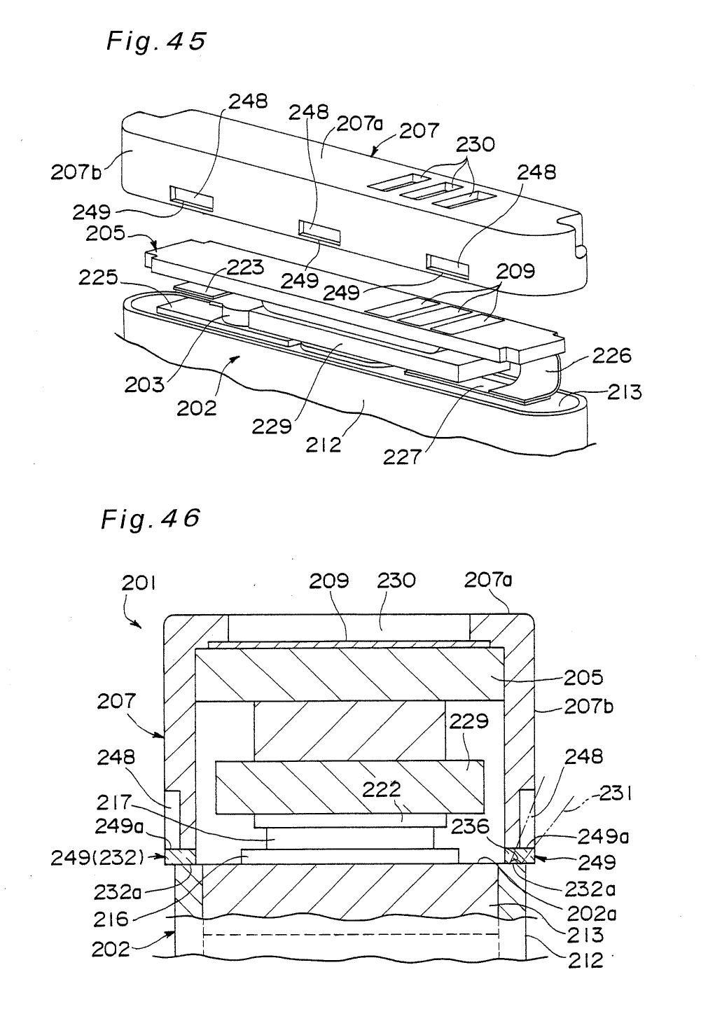

FIGS. 45 and 46 show a fourteenth embodiment of a battery pack according to the invention. In the fourteenth embodiment, some parts of outer periphery of a lower end of a peripheral side wall 207b of an exterior cover 207, specifically, some parts of the peripheral side wall 207b are recessed so as to form a plurality of recesses 248. Between bottom surfaces of inner peripheries, in the drawing, of the recesses 248 and the lower end face of the peripheral side wall 207b of the exterior cover 207 are formed thin wall parts 249. In the thin wall parts 249, top surfaces thereof in the drawing (i.e., the bottom surfaces of the inner peripheries, in the drawing, of the recesses 248) are formed as flat parts (flat surfaces) 249a placed generally in parallel with a top face 202a of a unit cell 202. Bottom surfaces of the thin wall parts 249 in the drawing form the lower end face of the peripheral side wall 207b of the exterior cover 207 and are placed in close contact with the peripheral edge portion of the top face 202a of the unit cell 202. The thin wall parts 249 allow permeation therethrough of visible light and a YAG laser beam 231. That is, the thin wall parts 249 are formed as laser permeable parts 232.

In the fourteenth embodiment, the YAG laser beam 231 is applied from above toward the flat parts 249a of the thin wall parts 249 of the exterior cover 207, with the exterior cover 207 put over a protection element 203 and a circuit board 205 and with the lower face of the exterior cover 207 being in close contact with the peripheral edge portion of the top face 202a of the unit cell 202. Thus the YAG laser beam 231 permeates through the thin wall part 249 and reaches a part (welding part) 236 that is irradiated with the YAG laser beam 231 in an close contact part between the lower end surface 232a of the thin wall part 249 of the exterior cover 207 and the peripheral edge portion of the top face 202a of the unit cell 202, so that the welding part 236 is molten and welded onto the peripheral edge portion of the top face 202a of the unit cell 202. Namely, the bottom surface 232a of the thin wall part 249 of the exterior cover 207 is welded and fixed by laser welding to the peripheral edge portion of the top face 202a of the unit cell 202. Other points are the same as those of the tenth embodiment and description thereof is therefore omitted.

In the bottom surfaces 232a of the thin wall parts 249 is included a lower end part of the exterior cover 207 that is inside the thin wall parts 249 with respect to the exterior cover 207. Though three thin wall parts 249 are formed on each of front and rear faces of the peripheral side wall 207b of the exterior cover 207 in FIG. 45, one laterally oblong thin wall part 249 may be formed on each of the front and rear faces of the peripheral side wall 207b of the exterior cover 207. The thin wall parts 249 may be formed on whole circumference of the peripheral side wall 207b of the exterior cover 207. The laser permeable parts 232 that allow permeation therethrough of visible light and the YAG laser beam 231 may be provided in only part of the thin wall parts 249. In this case, the YAG laser beam 231 is applied only to the laser permeable parts 232 that are provided partially in the thin wall parts 249.

It is to be noted that, by properly combining the arbitrary embodiments of the aforementioned various embodiments, the effects possessed by them can be produced.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

The entire disclosure of Japanese Patent Applications No. 2007-249714 filed on Sep. 26, 2007, No. 2007-251793 filed on Sep. 27, 2007, and No. 2007-256190 filed on Sep. 28, 2007, including specification, drawings, and claims are incorporated herein by reference in its entirety.

What is claimed is:

1. A battery pack comprising:
a unit cell including a battery case having an opening and a sealing plate closing and sealing the opening of the battery case, both of the battery case and sealing plate being made of metal;
a circuit board having a safety circuit; and
a holding member holding the circuit board and made of resin, wherein
at least part of the holding member is fixed to the unit cell by laser welding.

2. The battery pack as defined in claim 1, wherein
the holding member for holding the circuit board is an exterior cover that covers the circuit board and the sealing plate, the exterior cover being made of resin, and
at least part of an opening edge of the exterior cover is welded and fixed to the unit cell.

3. The battery pack as defined in claim 2, wherein a thin wall part is formed in the opening edge of the exterior cover so that a distance from a center of a welding region between the opening edge and the unit cell to an outer surface of the exterior cover is smaller than distances between outer and inner surfaces of the other parts of the exterior cover.

4. The battery pack as defined in claim 3, wherein a flat surface parallel to a welding surface between the exterior cover and the unit cell is formed in the thin wall part of the exterior cover, and a distance between the welding surface and the flat surface is smaller than the distances between the outer and inner surfaces of the other parts of the exterior cover.

5. The battery pack as defined in claim 4, wherein
a flange protruding outward is formed as the thin wall part on the opening edge of the exterior cover,
a surface of the flange continuing to the outer surface of the exterior cover is provided as the flat surface parallel to the welding surface, and
a surface of the flange opposed to the flat surface is welded and fixed to the unit cell.

6. The battery pack as defined in claim 4, wherein a skirt extending along an outer surface of the battery case is formed as the thin wall part on the opening edge of the exterior cover, and the outer surface of the battery case and inner surfaces of the skirt are welded and fixed to each other.

7. The battery pack as defined in claim 2, wherein
at least one welding protrusion is formed on periphery of an outer surface of the sealing plate of the unit cell, and
a surface of the welding protrusion and an inner peripheral surface of the exterior cover are welded and fixed to each other.

8. The battery pack as defined in claim 2, wherein a holder made of resin is placed between the circuit board and the sealing plate of the unit cell.

9. The battery pack as defined in claim 1, wherein
the holding member holding the circuit board is a holder that is placed on the sealing plate of the unit cell and holds the circuit board, the holder being made of resin,
the battery pack further comprises an exterior cover that covers the circuit board and the holder and that is fixed to the holder,
the holder includes a bottom wall that is placed on the sealing plate of the unit cell and side walls that are placed on outer periphery of the bottom wall and that hold the circuit board spaced apart from the bottom wall, and
at least part of the bottom wall of the holder is welded and fixed to the unit cell.

10. The battery pack as defined in claim 9, wherein thin wall part is formed on the bottom wall of the holder so as to have a wall thickness smaller than those of the other parts, and the bottom wall is welded and fixed to the sealing plate at a site where the thin wall part is formed.

11. The battery pack as defined in claim 9, wherein a skirt is formed by extension of part of the bottom wall of the holder along an outer surface of the battery case, and an outer surface of the battery case and an inner surface of the skirt are welded and fixed to each other.

12. The battery pack as defined in claim 9, wherein
at least one recess or protrusion is formed on an outer surface of the sealing plate of the unit cell,
an engaging part to be engaged with the recess or protrusion of the sealing plate is formed on an outer surface of the bottom wall of the holder, and
the recess or protrusion on the sealing plate and the engaging part on the bottom wall are welded and fixed to each other with both engaged.

13. The battery pack as defined in claim 9, wherein
an engaging part to be engaged with an inner surface of the exterior cover is provided on an outer surface of the side wall of the holder, and
the exterior cover is fixed to the holder by engagement of the engaging part.

14. The battery pack as defined in claim 9, wherein a protection element is held by the holder.

15. The battery pack as defined in claim 1, wherein a laser permeable part that allows permeation therethrough of laser beam for welding, the laser permeable part being made of resin, is formed in the holder in a position corresponding to region for welding to the unit cell.

16. The battery pack as defined in claim 3, wherein the thin wall part of the exterior cover is formed as a laser permeable part that allows permeation therethrough of laser beam for welding, the laser permeable part being made of resin.

17. The battery pack as defined in claim 9, wherein a laser permeable part that allows permeation therethrough of laser beam for welding, the laser permeable part being made of resin, is formed in the bottom wall of the holder, in positions corresponding to regions for welding to the unit cell.
